(19) United States
(12) Patent Application Publication
(10) Pub. No.: US 2019/0180553 A1
(43) Pub. Date: Jun. 13, 2019

(54) GAMING SYSTEM AND METHOD COMPRISING MONETARY AND NON-MONETARY PRIZES

(71) Applicant: Chill Gaming Pty Ltd, Southbank, VIC (AU)

(72) Inventors: Peter James HERRING, Box Hill South (AU); Joseph Ronald CREPALDI, Potts Point (AU); Andrew WYER, Glen Iris (AU); Daryl BRIDGES, Selby (AU); Daryl Leigh BRUCE, Croydon South (AU)

(21) Appl. No.: 16/324,514

(22) PCT Filed: Jul. 31, 2017
(86) PCT No.: PCT/AU2017/050795

§ 371 Date: Feb. 8, 2019

Related U.S. Application Data
(60) Provisional application No. 62/373,204, filed on Aug. 10, 2016.

(51) Int. Cl. G07F 17/32

(52) U.S. Cl. CPC G07F 17/326; G07F 17/3213; G07F 17/3244

(57) ABSTRACT

Embodiments generally relate to a gaming machine for awarding monetary and non-monetary rewards. The gaming machine comprises a display; a memory; at least one input mechanism configured to receive user input from a player; and a game controller. The game controller is configured to access and execute instructions stored in the memory to present at least one instance of at least one game of chance on the display; generate a randomised game outcome for the at least one instance of the at least one game of chance; access at least one non-monetary pay table; determine a first winning event for the at least one instance of the game of chance; access at least one monetary pay table; determine a second winning event for the at least one instance of the game of chance; based on the first winning event of the game of chance and the at least one non-monetary pay table, determine whether the player should be awarded a non-monetary reward; and based on the second winning event of the game of chance and the at least one monetary pay table, determine whether the player should be awarded a monetary reward.

### CROSS-REFERENCE TO RELATED APPLICATIONS

The present application is a U.S. National Phase Application under 35 U.S.C. § 371 of International Patent Application No. PCT/AU2017/050795, filed on 31 Jul. 2017 and entitled “Gaming system and method comprising monetary and non-monetary prizes,” the entire contents of which is hereby incorporated by reference. International Patent Application No. PCT/AU2017/050795 claims the benefit of U.S. Provisional Patent Application No. 62/373,204, filed on 10 Aug. 2016 and entitled “Gaming system and method comprising monetary and non-monetary prizes,” the entire contents of which is hereby incorporated by reference.

### TECHNICAL FIELD

The present disclosure relates to an improved gaming system and an improved method, system and machine for gaming.

### BACKGROUND

Reel-style gaming machines allow players to make bets on symbols that appear on the real or virtual reels, offering awards to players based on the combinations of symbols that appear. These games appeal to players as a way of winning cash or credits. However, it can be difficult to balance the need to make the gaming machines profitable with the need to create player satisfaction, as players can get bored and discouraged if they fail to win prizes.

It is desired to address or ameliorate one or more shortcomings or disadvantages associated with prior methods, systems and machines for gaming, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a gaming machine for awarding monetary and non-monetary rewards, the gaming machine comprising:
a display;
a memory;
at least one input mechanism configured to receive user input from a player; and
a game controller configured to access and execute instructions stored in the memory to:
   present at least one instance of at least one game of chance on the display;
   generate a randomised game outcome for the at least one instance of the at least one game of chance;
   access at least one non-monetary pay table;
   determine a first winning event for the at least one instance of the game of chance;
   access at least one monetary pay table;
   determine a second winning event for the at least one instance of the game of chance;
   based on the first winning event of the game of chance and the at least one non-monetary pay table, determine whether the player should be awarded a non-monetary reward; and
   based on the second winning event of the game of chance and the at least one monetary pay table, determine whether the player should be awarded a monetary reward.

According to some embodiments, the non-monetary reward contributes to progression in a chance based feature game. In some embodiments, the feature game comprises modifying a player object. In some embodiments, the feature game comprises collecting one or more player objects. According to some embodiments, the non-monetary reward is an aesthetic item that affects the appearance of a player object in the chance based feature game.

In some embodiments, the non-monetary reward includes at least one unit of in-game currency. In some embodiments, the in-game currency can be used to purchase an aesthetic item that affects the appearance of a player object in the chance based feature game.

According to some embodiments, the game controller is configured to determine whether the player should be awarded a non-monetary or monetary reward by comparing one or more symbols generated by the game of chance with the at least one non-monetary pay table and the at least one monetary pay table.

According to some embodiments, presenting the game of chance on the display involves presenting a plurality of symbols on the display. In some embodiments, the first winning event is determined based on a first characteristic of the plurality of symbols and the second winning event is determined based on a second characteristic of the plurality of symbols. In some embodiments, the first winning event is determined based on a first subset of the plurality of symbols and the second winning event is determined based on a second subset of the plurality of symbols.

According to some embodiments, the game of chance is a reel game. In some embodiments, the awarding of a non-monetary award is determined based on whether one or more predetermined reel symbols appear on the reel game. In some embodiments, the awarding of a monetary award is determined based on whether one or more predetermined reel symbols appear on the reel game.

In some embodiments, the gaming machine is configured to award monetary and non-monetary prizes based on a predetermined probability distribution. According to some embodiments, the probability distribution creates an inverse relationship between the probabilities of winning a monetary prize and a non-monetary prize. In some embodiments, the probability distribution creates a higher chance of winning only one of a monetary prize and a non-monetary prize compared to the chance of winning both of a monetary prize and a non-monetary prize or neither of a monetary prize nor a non-monetary prize. In some embodiments, the probability distribution creates a higher chance of winning at least one of a monetary prize and a non-monetary prize compared to the chance of winning neither a monetary prize nor a non-monetary prize.

According to some embodiments, the controller is further configured to store the monetary award in the memory, and generate an indication of the monetary award configured to be displayed on the display.

Some embodiments relate to a method of determining monetary and non-monetary prizes to be awarded, the method comprising:
presenting at least one instance of at least one game of chance on a display of a gaming machine;
generating a randomised game outcome for the at least one instance of the at least one game of chance;
accessing at least one non-monetary pay table;
determining a first winning event for the at least one instance of the at least one game of chance;
accessing at least one monetary pay table
determining a second winning event for the at least one instance of the at least one game of chance;
based on the first winning event of the game of chance and the at least one non-monetary pay table, determining whether the player should be awarded a non-monetary reward; and
based on the second winning event of the game of chance and the at least one monetary pay table, determining whether the player should be awarded a monetary reward.

Some embodiments further comprise determining whether the player should be awarded a monetary reward by comparing one or more symbols generated by the game of chance with the at least one monetary pay table.

Some embodiments further comprise accessing at least one non-monetary pay table to determine whether the player should be awarded a non-monetary reward.

Some embodiments further comprise determining whether the player should be awarded a non-monetary reward by comparing one or more symbols generated by the game of chance with the at least one non-monetary pay table.

According to some embodiments, the non-monetary reward contributes to progression in a chance based feature game.

Some embodiments relate to a computer-readable medium storing machine-readable instructions, which when executed by a processor, causes the processor to perform the method of some other embodiments.

### BRIEF DESCRIPTION OF DRAWINGS

Embodiments are described below in further detail and by way of example, with reference to the accompanying drawing, in which:

FIG. 1 is a diagrammatic representation of a gaming system in accordance with some embodiments, implemented in the form of a stand-alone gaming machine;

FIG. 2 is a schematic block diagram of core components of the gaming system of FIG. 1;

FIG. 3 is a schematic diagram of a gaming system in accordance with some embodiments, with the gaming system implemented over a network;

FIG. 4 is a schematic block diagram of the software components of a gaming system according to some embodiments;

FIG. 5 is a flow diagram illustrating a method of controlling game play on a gaming machine according to some embodiments;

FIG. 6 is an example screenshot of an avatar selection screen;

FIG. 7 is an example screenshot of a virtual location selection screen;

FIG. 8 is an example screenshot of a base game screen;

FIG. 9 is a detailed view of the symbol sets shown in FIG. 8;

FIG. 10 is an example screenshot of a base game screen;

FIG. 11 is an example screenshot of a meta-game task screen;

FIG. 12A is an example screenshot of a meta-game task screen showing a task being completed;

FIG. 12B is a detailed view of an example player level bar portion of the base game screen;

FIG. 12C is an example screenshot of the base game screen highlighting a winning meta-game combination;

FIG. 13 is an example screenshot of a feature game screen for a progression type game;

FIG. 14 is an example screenshot of a feature game screen for a collection type game;

FIG. 15 is an example screenshot of a feature game screen for a hybrid progression-collection type game;

FIG. 16 is an example chart to illustrate the awarding of monetary and non-monetary awards according to some embodiments;

FIG. 17 is an example screenshot of a base game screen according to some embodiments; and

FIG. 18 is a graph showing an example probability distribution for awarding monetary and non-monetary prizes in accordance with some embodiments.

### DESCRIPTION OF EMBODIMENTS

Described embodiments generally relate to a gaming machine. The gaming system can take a number of different forms. In a first form, a stand-alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in standalone gaming machine mode, “thick client” mode or “thin client” mode depending on the game being played, operating conditions, and so on.

Irrespective of the form, the gaming system 100 has several core components. At the broadest level, the core components comprise a player interface and a game controller. The player interface is arranged to enable interaction between a player and the gaming system and for this purpose includes input/output components required for the player to enter instructions and play the game. For example, the input/output components may include a credit mechanism to enable a player to input credits and receive payouts, one or more displays which may comprise a touch screen, and a game play mechanism arranged to enable a player to input game playing instructions. The game controller is in data communication with the player interface and typically comprises a processor arranged to process game play instructions and output game player outcomes to the one or more displays. It will be understood that in the present specification, the term “processor” refers generally to any device that can process game play instructions and may include a microprocessor, microcontroller, programmable logic device or any computational device such as a personal computer or a server.

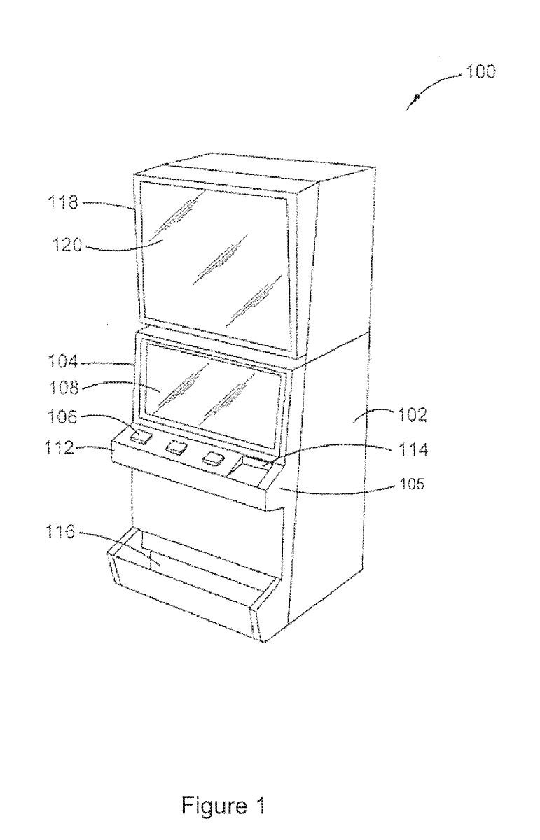

Referring now to FIG. 1, reference numeral 100 generally designates a stand-alone gaming system including a game. Hereinafter, the stand-alone gaming system 100 will be referred to as a gaming machine.

The gaming machine 100 includes a console 102 which contains all or most components required to implement a game play whereby, at least during part of the game play, a player wins or loses a wager. Access to the components is by way of a hinged door 105. Mounted to the exterior of the console 102 is a display means in the form of at least one visual display unit 104 on which one or more games is played. The video display unit 104 may be implemented as a liquid crystal display, a plasma screen, or other high quality digital video display. While the console 102 illustrated in FIG. 1 shows a single visual display unit 104, there may be more than one visual display unit on a gaming machine 100. For example, in some embodiments, gaming machine 100 may have one visual display unit 104 for displaying the game being played, and an additional visual display unit in the form of artwork 120 (described below) for displaying advertising or other material. In some embodiments, the additional visual display unit may be a video display unit. What is displayed on the visual display unit 104 will depend on what the intended goal of the unit is in relation to the player and any other potential participants in the gaming system. In some embodiments, a plurality of gaming machines 100 may communicate with a central display screen (not shown), which may allow for portions of gameplay to be displayed to a wider audience in a gaming venue.

In this example, the gaming machine 100 includes a tactile input for a player to interact via touch with the gaming machine 100. The tactile input may be in the form of a combination of pushbuttons 106 and a touch screen 108 for enabling a player to play one or more games. The touch screen 108 is an electronic visual display that can detect the presence and location of a touch within the display area. The touch screen 108 may be used during game setup, user browsing, or during the game play between start of a game and the end of a game, for example. Certain functions of the pushbutton are: initiation of game play, credit output, gameplay selection, completion of gameplay etc. A midtrim 112 of the machine 100 houses the pushbuttons 106.

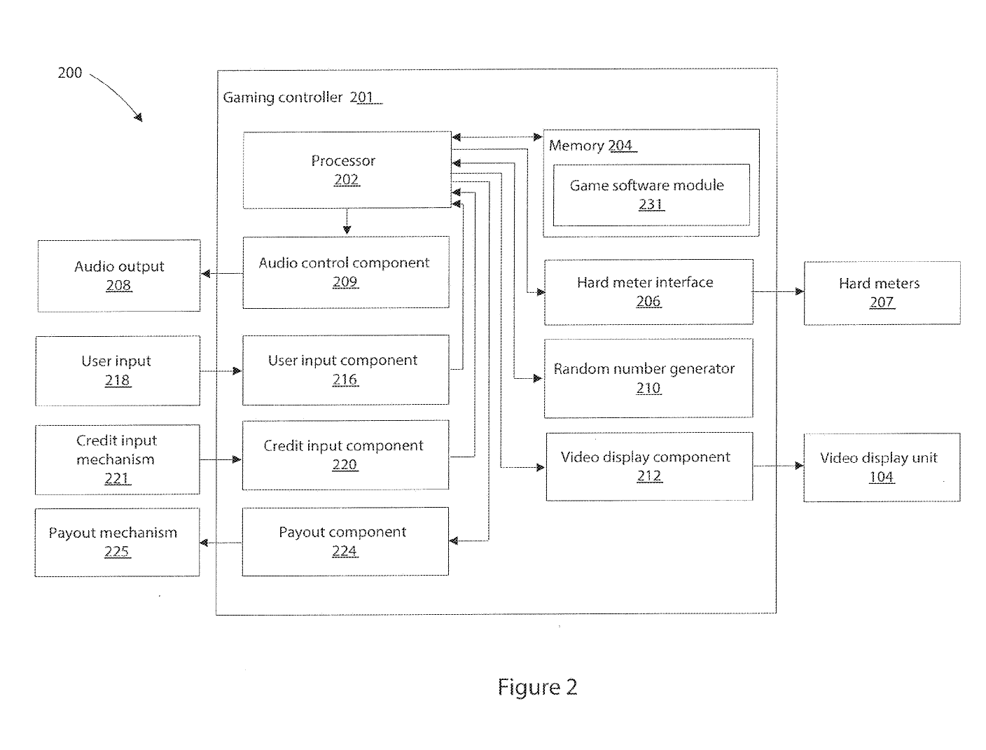

The tactile input may optionally or further include a joystick (not shown) comprising a stick that pivots on a base and reports its angle or direction to the device it is controlling. The tactile input may optionally or further include a trackpad/touchpad (not shown) being a pointing device featuring a tactile sensor to translate the motion and position of a user's fingers to a relative position on screen. In some embodiments, tactile input may further include a keyboard, electronic mouse, or other input mechanism. In some embodiments, the user interface may be a user configurable interface having multiple user input options. It should be appreciated that tactile input may include any suitable device that enables the player to produce an input signal that is received by the processor 202 (see FIG. 2).

The midtrim 112 may house a credit input mechanism 221 including a bill collector 114. The credit input mechanism 221 may alternatively or additionally include a coin input chute, a card and/or ticket reader, a magnetic reading head for reading a magnetic stripe card, an electronic reader for a proximity card, a near field communications reader or any other form of electronic, wireless or contact that can input credit to the gaming machine.

A payout mechanism 225 including a coin tray 116 may be mounted beneath the console 102 and is provided for cash or other payouts from the machine 100 to the player. A hopper device (not shown) is provided which dispenses coins, or tokens equal to the amount of credit currently on the machine, into the coin tray 116. Aside from the coin tray 116, payout mechanism 225 may alternatively or additionally include a ticket dispenser for issuing a ticket dispensed by a printer which the user can redeem for cash, a note dispenser, a near field communications transmitter or means to enable remote credit transfer. Other suitable payout mechanisms, such as fund transfers to the player's electronically recordable identification card or smart card, may be implemented in accordance with described embodiments.

The gaming machine 100 includes a top box 118 on which artwork 120 or other images may be carried in the form of electronic visual display units. The artwork 120 could also comprise physical materials such as paper, plastic banners or posters. The artwork 120 may have generic information related to the machine or gaming system or the artwork 120 may be specifically made for a particular game to be played on the machine 100. While the artwork 120 is shown as being carried on the top box 118, the art work 120 can also be positioned in or on the bottom panel of the door 105, or any other part of the gaming machine 100 visible to the player. In some embodiments, artwork 120 may be a second digital display, which may show jackpot information, for example, or other supplemental video.

The gaming machine 100 further includes an auditory unit in the form of auditory output 208 (see FIG. 2) to provide auditory feedback to the player of the gaming machine 100.

Referring to FIG. 2, game logic circuitry 200 is illustrated. The game logic circuitry 200 includes a gaming controller 201 (otherwise referred to as a logic cage). As will be appreciated by those skilled in the gaming industry, the logic cage 201 includes a box-like mechanical structure that has slots to guide logic cards into the proper location for electronically plugging into a backplane mounted at the rear of the cage structure. The logic cards may contain hardware configured to perform specific functions, and may include sound cards, video cards, network cards, hard drives or other memory storage. The backplane has connectors for accepting mating connectors on the logic cards. The logic cage 201 and associated logic cards form one of the basic components of the gaming machine 100 and is securely housed within the cabinet of the gaming machine 100.

Central to the logic cage 201 is a processor 202 which may be a central processing unit, a microcontroller-based platform, a suitable integrated circuit, or one or more application-specific integrated circuits (ASIC's).

In this particular example, the processor 202 is in communication with or operable to access or to exchange signals with: memory 204, an audio control component 209, a hard meter interface 206, a random number generator 210, a user input component 216, a video display component 212, a credit input component 220 and a payout component 224.

Instructions and data to control operation of the processor 202 are stored in a memory 204 which is in data communication with processor 202. Memory 204 typically comprises both volatile and non-volatile memory and more than one of each type of memory. For example, the memory 204 may comprise RAM, ROM, and non-volatile memory in the form of a memory card, such as compact flash. RAM may include non-volatile RAM (NVRAM), magnetic RAM (MRAM), ferroelectric RAM (FeRAM), and other forms as commonly understood in the gaming industry. Memory 204 comprises a game software module 231 storing executable code, which when executed by the processor 202, provides the game on the gaming machine 100.

In particular, processor 202 runs executable code residing in game software module 231 of memory 204 that facilitates play of a game by a player through display unit 104 and/or push buttons 106 and touch sensors 108 mounted in the screen of display unit 104. Game software module 231 contains executable program code that defines the rules of the game, defines the sequence of gameplay, communicates with external systems, monitors peripheral equipment, and maintains integrity of the software code, among other things.

Audio control component 209 is in communication with audio output 208. Audio control component 209 may have its own digital signal processor, analogue to digital converters, amplifiers and other circuitry necessary to broadcast the output from the speakers.

Hard meter interface 206 communicates with hard meters 207. Hard meters 207 contain the gaming machine parameters which are required to be stored on a hard meter for regulatory reasons, which may include values such as total credit in and total credit out in some jurisdictions, for example. The values in hard meters 207 are only ever incremented, and cannot be reset or decremented.

Random number generator 210 generates random or pseudo-random numbers for the purpose of determining the outcome of chance-based games played on gaming machine 100. In some embodiments, random number generator 210 may be implemented in software as part of game software module 231. In some other embodiments, random number generator 210 may be implemented in firmware or in hardware. In some embodiments, the form that random number generator 231 takes may be dictated by gaming regulations.

User input component 216 communicates with user inputs 218, which may include pushbuttons 106 and touch screen sensors 108, among other inputs. Received inputs are decoded by user input component 216 and communicated to processor 202.

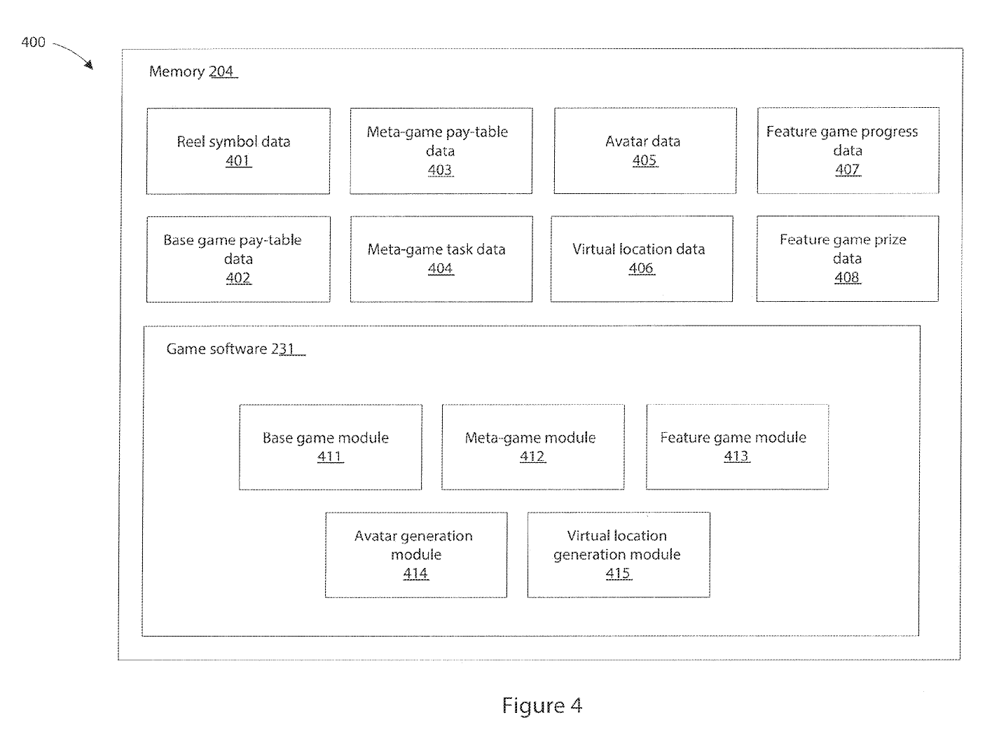

Video display component 212 communicates with video display unit 104. Processor 202 sends instructions to video display component 212, in order to cause images that make up the game sequence to be displayed on video display unit 104. These images may be pre-generated images retrieved by processor 202 from memory 204, or the images may be generated in real-time by processor 202 executing code modules stored in memory 204, as described below with reference to FIG. 4. In some embodiments, the displayed images may be made up of a pre-generated background retrieved from memory 204 in combination with an animated sequence generated in real-time by processor 202.

Credit input component 220 receives signals from credit input mechanism 221, which may include bill collector 114 in some embodiments. Credit input component 220 may use the signals to determine whether or not a player has provided sufficient credit to commence or continue gameplay, for example.

Payout component 224 communicates with payout mechanism 225, which may include coin tray 116. Payout component 224 may send instructions to payout mechanism 225, to cause payout mechanism 225 to dispense payment to a player. The payout may be in the form of cash, tokens or tickets in some embodiments. In some embodiments, the player may receive a code which they can use to collect their payout from a designated kiosk. In some embodiments, a player card or account may be credited with the payout amount. In some embodiments, a player may be able to finish game play and request a payout at various stages throughout the game. In some embodiments, players may be able to request a payout at any stage of the game. The player may be able to use user input 118 to request the payout.

In some embodiments, a player may insert an identification card or ticket into a card reader (not shown) of the gaming machine 100, in order to load information onto gaming machine 100. For example, the identification card or ticket may be associated with a player account containing credit, player settings, and player progress in a game. Such an identification card may be a smart card having a programmed microchip, a coded magnetic strip, or coded rewritable magnetic strip, wherein the programmed microchip or magnetic strips are coded with a player's identification, credit totals (or related data), and/or other relevant information. In another embodiment, a player may carry a portable device, such as a mobile phone, a radio frequency identification tag, or any other suitable wireless device, that communicates a player's identification, credit totals (or related data), and other relevant information to the gaming device.

One or more of the method steps described in this disclosure may be implemented by game software module 231 stored in memory 204. Instructions stored in game software module 231 may be executed by processor 202 or any other processor. Further, the processor 202, the memory 204, the game software module 231 stored therein, or a combination thereof, may serve as a means for performing one or more of the method steps described herein.

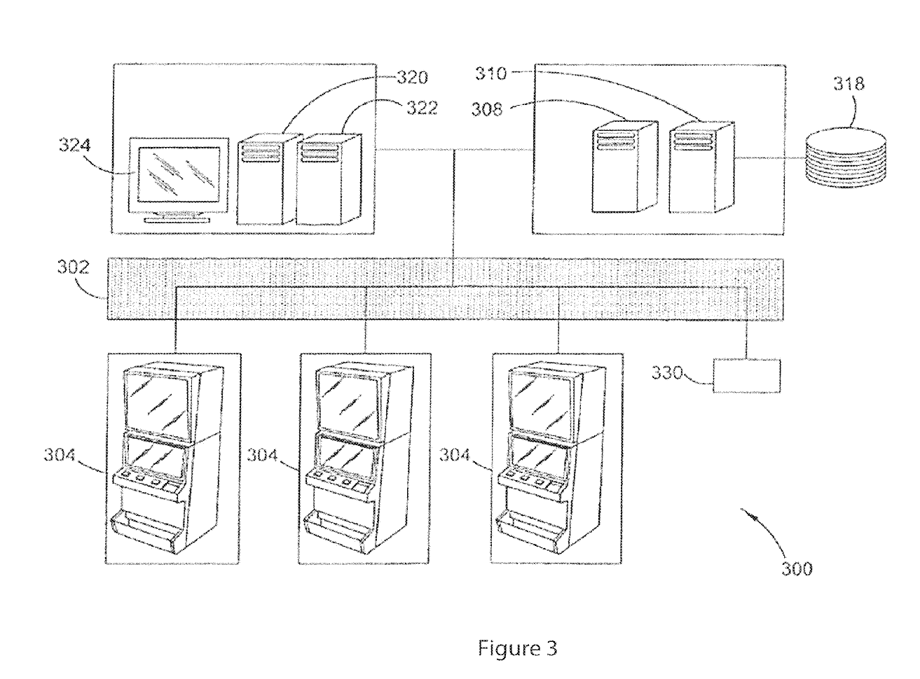

FIG. 3 shows a gaming system 300 in accordance with an alternative embodiment. The gaming system 300 includes a network 302, which for example may be or include an Ethernet, powerline, multimedia over Coax (MoCA), WiFi, or other type of network. The network 302 may also comprise a wide area network (“WAN”), the plain-old-telephone-system (“POTS), a local area network (“LAN”), a wireless LAN, the Internet, or any combination of these and other types of networks. Gaming machines 304 are connected to the network 302. The gaming machines 304 provide a player operable interface and may be the same as the gaming machines 100 shown in FIG. 1 or may have simplified functionality depending on the requirements for implementing game play.

Gaming machines 304 may include game logic circuitry 200 as described above with reference to FIG. 2. Gaming machines 304 may further include a console similar to console 102 which contains all or most components required to implement a game play whereby, at least during part of the game play, a player wins or loses a wager. Access to the components may be by way of a hinged door, which may be similar to hinged door 105. Mounted to the exterior of the console may be a display means in the form of at least one visual display unit, which may be similar to display unit 104, on which one or more games is played. The display unit may be implemented as a liquid crystal display, a plasma screen, or other high quality digital video display. There may be more than one visual display unit on each gaming machine 304. For example, in some embodiments, gaming machines 304 may have one visual display unit for displaying the game being played, and an additional visual display unit in the form of artwork similar to artwork 120 (described below) for displaying advertising or other material. In some embodiments, the additional visual display unit may be a video display unit. What is displayed on the visual display unit will depend on what the intended goal of the unit is in relation to the player and any other potential participants in the gaming system. In some embodiments, a plurality of gaming machines 304 may communicate with a central display screen (not shown), which may allow for portions of gameplay to be displayed to a wider audience in a gaming venue.

Gaming machines 304 may include a tactile input for a player to interact via touch with the gaming machines 304. The tactile input may be in the form of a combination of pushbuttons and a touch screen similar to push-buttons 106 and a touch screen 108, for enabling a player to play one or more games. The touch screen may be an electronic visual display that can detect the presence and location of a touch within the display area. The touch screen may be used during game setup, user browsing, or during the game play between start of a game and the end of a game, for example. Certain functions of the push-button may include: initiation of game play, credit output, gameplay selection, completion of gameplay etc. A midtrim of the machine 304, similar to midtrim 112, may house the push-buttons.

The tactile input may optionally or further include a joystick comprising a stick that pivots on a base and reports its angle or direction to the device it is controlling. The tactile input may optionally or further include a trackpad/touchpad being a pointing device featuring a tactile sensor to translate the motion and position of a user's fingers to a relative position on screen. In some embodiments, tactile input may further include a keyboard, electronic mouse, or other input mechanism. In some embodiments, the user interface may be a user configurable interface having multiple user input options.

The midtrim of gaming machine 304 may house a credit input mechanism including a bill collector, similar to credit input mechanism 221 and bill collector 114. The credit input mechanism may alternatively or additionally include a coin input chute, a card and/or ticket reader, a magnetic reading head for reading a magnetic stripe card, an electronic reader for a proximity card, a near field communications reader or any other form of electronic, wireless or contact that can input credit to the gaming machine.

A payout mechanism including a coin tray, similar to payout mechanism 225 and coin tray 116, may be mounted beneath the console and may be provided for cash or other payouts from the machine 1304 to the player. A hopper device may be provided which dispenses coins, or tokens equal to the amount of credit currently on the machine, into the coin tray. Aside from the coin tray, the payout mechanism may alternatively or additionally include a ticket dispenser for issuing a ticket dispensed by a printer which the user can redeem for cash, a note dispenser, a near field communications transmitter or means to enable remote credit transfer. Other suitable payout mechanisms, such as fund transfers to the player's electronically recordable identification card or smart card, may be implemented in accordance with described embodiments.

The gaming machine 304 may include a top box similar to top box 118 on which artwork similar to artwork 120 or other images may be carried in the form of electronic visual display units. The artwork could also comprise physical materials such as paper, plastic banners or posters. The artwork may have generic information related to the machine or gaming system or the artwork may be specifically made for a particular game to be played on the machine 304. While the artwork is shown as being carried on the top box, the art work can also be positioned in or on the bottom panel of the door, or any other part of the gaming machine 304 visible to the player. In some embodiments, the artwork may be a second digital display, which may show jackpot information, for example, or other supplemental video.

The gaming machines 304 further include an auditory unit in the form of auditory output 208 (see FIG. 2) to provide auditory feedback to the player of the gaming machine 304.

In a thick client embodiment, game server 308 implements part of the game played by a player using a gaming machine 304 and the gaming machine 304 implements part of the game. With this embodiment, as both the game server 308 and the gaming machine 100 implement part of the game, they collectively provide a game controller having similar functions to controller 201. A database management server 310 may manage storage of game programs and associated data for downloading or access by the gaming devices 304 in a database 318.

In a thin client embodiment, game server 308 implements most or all of the game played by a player using a gaming machine 304 and the gaming machine 304 essentially provides only the player interface. With this embodiment, the game server 308 provides the game controller. The gaming machine 304 will receive player instructions, pass these to the game server 305 which will process them and return game play outcomes to the gaming machine 304 for display. In a thin client embodiment, the gaming machines could be computer terminals, e.g. PCs running software that provides a player interface operable using standard computer input and output components.

Additional servers may be provided to assist in the administration of the gaming network 300, including for example a gaming floor management server 320, and a licensing server 322 to monitor the use of licenses relating to particular games. An administrator terminal 324 is provided to allow an administrator to run the network 302 and the devices connected to the network.

The gaming system 300 may communicate with other gaming systems, other local networks, for example a corporate network, and/or a wide area network such as the Internet, for example through a firewall 330.

In some embodiments, functionality at the server side of the network may be distributed over a plurality of different physical computers. For example, functional software elements may be run as a single “engine” on one server or a separate server may be provided. For example, the game server 308 could run a random number generator engine. Alternatively, a separate random number generator server could be provided. Further, in some embodiments a plurality of game servers could be provided to run different games or a single game server may run a plurality of different games as required by game machines 304.

A functional block diagram 400 illustrating software components of gaming machine 100 is shown in FIG. 4. Memory 204 stores game software module 231 which comprises a number of executable code modules. Memory 204 also stores various game data.

Game data stored by memory 204 includes symbol data 401, base game pay-table data 402, meta-game pay-table data 403, meta-game task data 404, player object data 405, virtual location data 406, feature game progress data 407, and feature game prize data 408. In some embodiments, memory 204 may further store information about one or more game themes or game scenarios, which may be selectable by a player of the game, or automatically selected prior to game commencement. A theme may include a number of conceptually linked game aspects that contribute to the overall appearance and/or style of the game, as well as the specific appearance of various aspects of the game, as described below. A scenario may be linked to a game theme, or vice versa, and may include details of the game style, game objectives, and storyline of the game.

Symbol data 401 may include data relating to the symbols to be displayed on visual display unit 104 of gaming machine 100 during the base game. For example, the particular images used for each symbol may be stored, as well as an identification code relating to the symbol, and a value of the symbol in the base game. The visual appearance of the symbols may be dependent on the theme of the game.

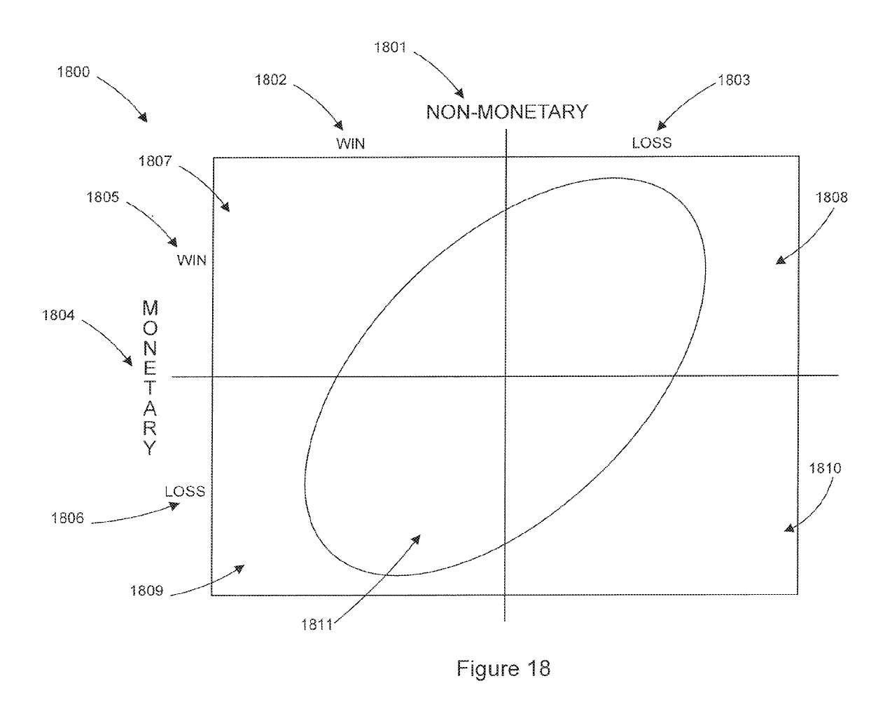

Base game pay-table data 402 may include data relating to the pay-table used in the base game played on gaming machine 100. Base game pay-table data 402 may be used to calculate an amount of points, credits or other awards to be won by a player of gaming machine 100 when playing the base game. Base game pay-table data 402 may be used to determine the amount won based on which combination of symbols appear on visual display unit 104. Base game pay-table data 402 may be related to symbol data 401, as the amount won by a player as determined by the value of the symbols as stored in symbol data 401. Base game pay-table data 402 have a predetermined probability distribution as described below with reference to FIG. 18. Base game pay-table data 402 may also store an award schedule for the awarding of meta-game awards. Base game pay-table data 402 may be static data that is programmed into memory 204 during development.

Meta-game pay-table data 403 may include data relating to the pay-table used in the meta-game played on gaming machine 100. Pay-table data 403 may be used to calculate an amount of points, credits or other awards to be won by a player of gaming machine 100 when playing the meta-game. Pay-table data 403 may be used to determine the amount won based on which combination of symbols appear on visual display unit 104. Meta-game pay-table data 403 may be related to symbol data 401. In some embodiments, meta-game pay-table data 403 may also be related to base game pay-table data 402, so that outcomes or winning events of the meta-game may be related to outcomes or winning events of the base game. Meta-game pay-table data 403 may be designed according to a predetermined probability distribution of winning meta-game events, as described below with reference to FIG. 18.

According to some embodiments, base game pay-table data 402 may be used to determine whether the player should be awarded a monetary reward, and meta-game pay-table data 403 may be used to determine whether a player should be awarded a non-monetary reward, based on the outcome of a game of chance presented on gaming machine 100. Processor 202 may be configured to access base game pay-table data 402 and meta-game pay-table data 403 and to compare the randomized game-play result of the game of chance with the pay table data to determine whether one or more monetary and/or non-monetary prizes should be awarded. According to some embodiments, the non-monetary prizes may include progressing through a meta-game task.

Meta-game task data 404 may include data relating to tasks to be completed by the player during a meta-game played on gaming machine 100. For example, meta-game task data 404 may include information about how many tasks a player needs to complete before they receive an award or obtain a particular level. Task data 404 may further include information about the symbol outcomes that may cause a task to be determined to have been completed. In some embodiments, meta-game task data 404 may be related to meta-game pay-table data 403, in order to allow the completion tasks to be completed based on outcomes as determined from the meta-game pay-table data 403.

According to some embodiments, meta-game task data 404 may be used to determine whether the player should be awarded a non-monetary reward, based on the outcome of a game of chance presented on gaming machine 100. Processor 202 may be configured to access meta-game pay-table data 403 and to compare the results of the game of chance with the meta-game pay-table data 403 to determine whether the game outcome results in progress in a meta-game task as defined by meta-game task data 404. For example, progress in the meta-game may be made when a certain combination of symbols are displayed in the game of chance. Once a pre-determined level of progress in a meta-game task has been completed, processor 202 may be configured to determine that the task has been completed, and to reward the player with a non-monetary reward.

Meta-game task data 404 may also be related to location data 406 and player object data 405, as the specific tasks to be completed may depend on the location and player object selected by the player. In some embodiments, meta-game task data 404 may relate to game theme or game scenario data as well as or instead of location data 406. The tasks may also be dependent on the current theme of the game. The theme of the game may change over the course of playing the game. For example, once a player has completed one or more meta-game objectives and the feature game in a particular map location (having a particular associated theme), the player may elect to move to another map location that has a different associated theme. In some alternative embodiments, the theme and/or scenario of the game may be selectable by a player independent of or instead of the location.

Player object data 405 may include data relating to one or more objects selected by or allocated to a player playing a game on gaming machine 100. Player object data 405 may include information about player objects available for access by the player, including an object name, the object type, and the initial appearance of the object. In some embodiments, player object data 405 may also include data particularly relating to a player object selected by the player, and any modified attributes of the object, such as changes to the appearance of the object achieved through game play. The objects available to the player in a particular game may be dependent on the theme of the game. In some embodiments, the object may be an avatar, character or player persona with graphical representation. The avatar, character or player persona may be a representation of a living being such as a human, animal, or fictional being, or may be a representation of an inanimate object such as vehicle, house, card, or other item. The object may be an animated graphical representation in some embodiments. According to some embodiments, the player object may be a graphical representation of one or more upgradable, modifiable or collectable objects. According to some embodiments, the player object may be one or more digital objects, such as a sound file, image file or movie file, for example. According to some embodiments, a player may be able to select or collect more than one player object during the course of gameplay.

Virtual location data 406 may include data relating to a virtual location selected by a player for playing a game on gaming machine 100. Virtual location data 406 may include information about available locations including a location name, one or more images of the location, and characteristics about the location. Virtual location data 406 may be related to player object data 405, as the available player objects may depend on the chosen location or vice versa. Virtual location data 406 may also be related to the meta-game task data 404, as the tasks presented during the meta-game may depend on the location selected. Virtual location data 406 may further be related to the symbol data 401, as the symbols presented during the base game may depend on the location selected. The current theme of a particular game may be dependent on the current selected virtual location of the game. Alternatively, locations available in a particular game may be dependent on the theme of the game. In some embodiments, the virtual location may change based on a scenario selected by the player. In some embodiments, the same virtual location may be used in all or some of a number of game scenarios.

Feature game progress data 407 may include data relating to the progress of a player through a feature game played on gaming machine 100. Feature game progress data 407 may include information about the stages of the feature game, such as how a player object may be affected as the player achieves each stage, as well as data defining or otherwise relating to what is required to move through each stage of the feature game. Feature game progress data 407 may be related to virtual location data 406, as the feature game theme may be determined based on the virtual location selected or vice versa. Feature game progress data 407 may further be related to player object data 405, as the game progress may be different for each player object selected. Feature game progress data 407 may also be dependent on the current theme of the game.

Feature game prize data 408 may include data relating to an amount of points, credits or other awards to be won by a player of gaming machine 100 when playing the feature game. Feature game prize data 408 may include information about how many awards are to be included in the feature game, and at what stages of the feature game they should be awarded. Feature game prize data 408 may be related to feature game progress data 407, in order to allow for the awards to be awarded based on progress through the game.

In some embodiments, the game machine 100/304 may have an overall theme for all of the game play, plus a number of sub-themes for different parts or stages of base game play and/or meta-game play and/or feature game play.

In some embodiments, code modules within game software module 231 may include base game module 411, meta-game module 412, feature game module 413, player object generation module 414, virtual location generation module 415, and/or other code modules.

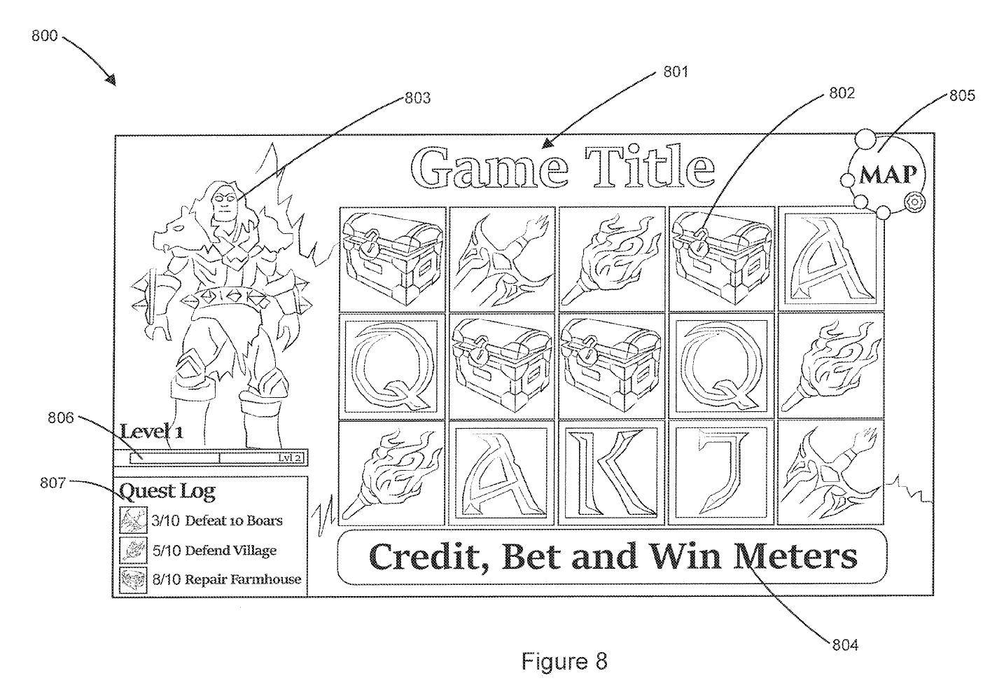

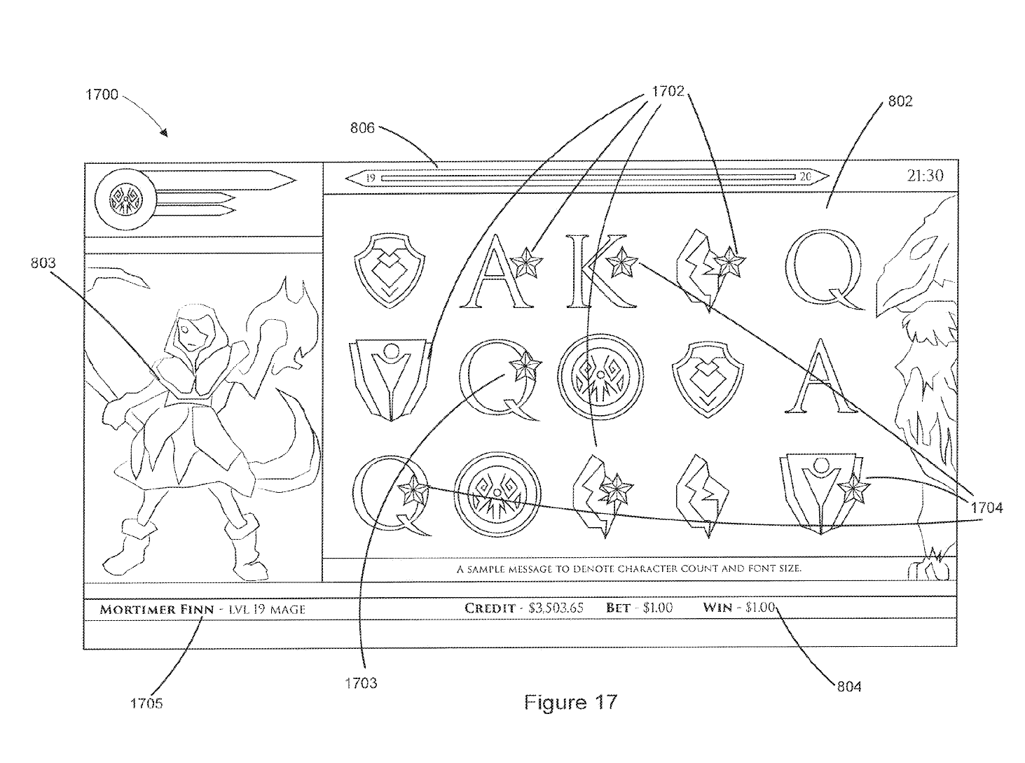

Base game module 411 may be executable by processor 202 to cause a base game, which may be a reel-type game in some embodiments, to be displayed on visual display unit 104. The base game may be any chance-based game, in which random number generator 210 is used to generate a symbol sub-set, such as a two-dimensional array of symbols, is randomly selected from a larger symbol set for display on visual display unit 104, with or without the appearance of spinning reels. According to some embodiments, random number generator 210 is used to determine the stopping position of each reel of a set of virtual reels for display on visual display unit 104. Each virtual reel may comprise a plurality of symbols, and reels may include in the order of 20, 40 or 60 symbols in some embodiments. The symbol set from which the displayed symbol subset is randomly selected for the base game is sized to permit a reasonable degree of variation among the selected symbols across a significant number of instances of symbol sub-set generation. The symbol sub-set may include multiple instances of the same symbol. According to some embodiments, at least some symbols in each virtual reel may include an overlay symbol, as described below with reference to FIG. 17. According to some embodiments, the symbols in the symbol set may be free of overlay symbols, as described below with reference to FIGS. 8, 9 and 10.

According to some embodiments, multiple instances of the same symbol may have different overlays, or the same overlay in some embodiments. According to some embodiments, the overlays may be distributed so that it is rare for multiple instances of the same overlay to be presented. For example, where one of the overlay symbols is a gold star, it may be relatively rare to have an outcome containing five gold stars. Where the chance-based game is not a reel type game, a two-dimensional array of symbols may be randomly selected from a larger symbol set having a similar probabilistic distribution as that of the reel game described above.

Base game module 411 may be executed when a player initiates game play using user input 218. Base game module 411 may allow a player to make a bet or wager using credit input mechanism 221, input mechanisms 106, and user input 218, and may determine a random game outcome using random number generator 210. Executing base game module 411 may cause processor 202 to determine whether the player won any credits or other awards using base-game pay-table data 402. Processor 202 may then cause gaming machine 100 to credit the player with any winnings using payout mechanism 225.

Meta-game module 412 may be executable by processor 202 to cause a meta-game to be shown on visual display unit 104. In some embodiments, the meta-game may include a reel-based game, and may use the same reels as those used for the base game. The meta-game may be any chance-based game, in which random number generator 210 is used to generate a symbol sub-set, such as a two-dimensional array of symbols, that is randomly selected from a larger symbol set for display on visual display unit 104 with or without the appearance of spinning reels. According to some embodiments, random number generator 210 is used to determine the stopping position of each reel of a set of virtual reels for display on visual display unit 104. The symbol set from which the displayed symbol subset is randomly selected for the meta-game is sized to permit a reasonable degree of variation among the selected symbols across a significant number of instances of symbol sub-set generation. The symbol sub-set may include multiple instances of the same symbol.

In some embodiments, meta-game module 412 may be executed when a player initiates game play using user input 218. Meta-game module 412 may include a series of tasks which must be completed. In some embodiments, the completion of the tasks is dependent on the appearance of certain symbols or combinations of symbols in a randomly generated symbol sub-set in the base game. For example, a particular symbol or combination of symbols appearing as part of the base game may contribute to the completion of a task. The base game and meta-game may therefore rely on the same randomly generated symbol sub-set, although a winning symbol combination in the base game may not also be a winning symbol combination in the meta-game. In other words, the same symbol subset upon which the outcomes of the base game and meta-game are based can lead to different results in each of the base game and meta-game. For example, a winning result in the base game may not correspond with a winning result in the meta-game and vice versa.

Additionally, according to some embodiments, while a winning result in the base game provides monetary reward, a winning result in the meta-game provides non-monetary reward, such as an aesthetic item that can be applied to a player object, the progression of a player object from one form into another, or an additional player object to be added to a player's collection of player objects, for example. In some embodiments, a winning result in the meta-game may additionally or alternatively lead to the direct award of a non-monetary reward. According to some embodiments, the non-monetary reward may include a real world reward, such as a meet-and-greet with a celebrity or other subjectively (but not objectively) valuable activities or opportunities, tickets to a show, game downloads, or other non-monetary prizes.

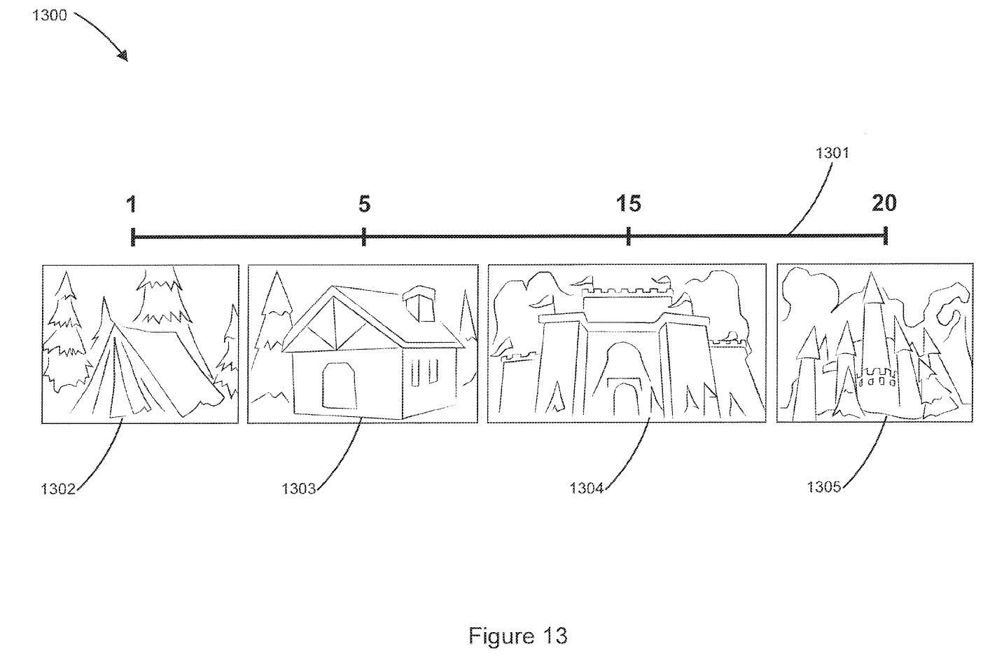

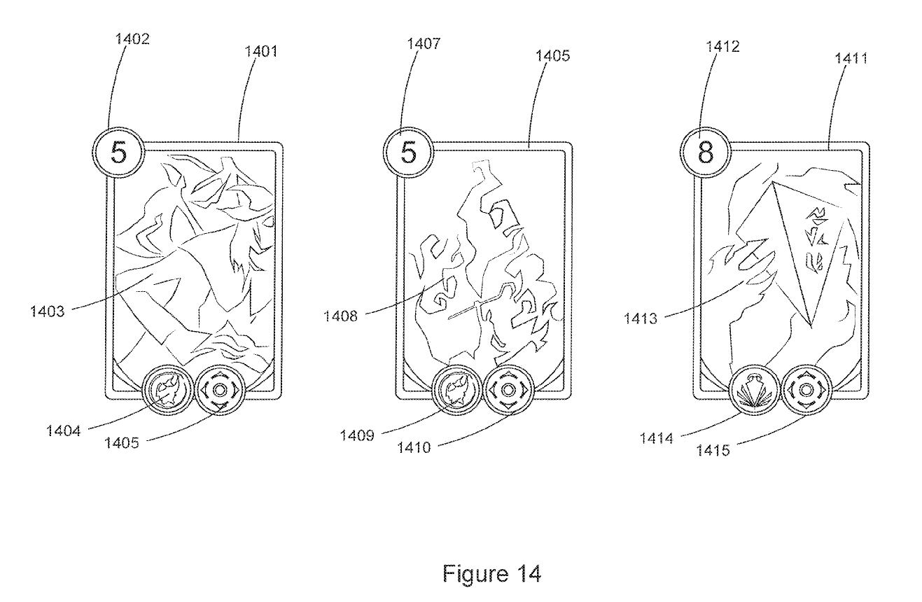

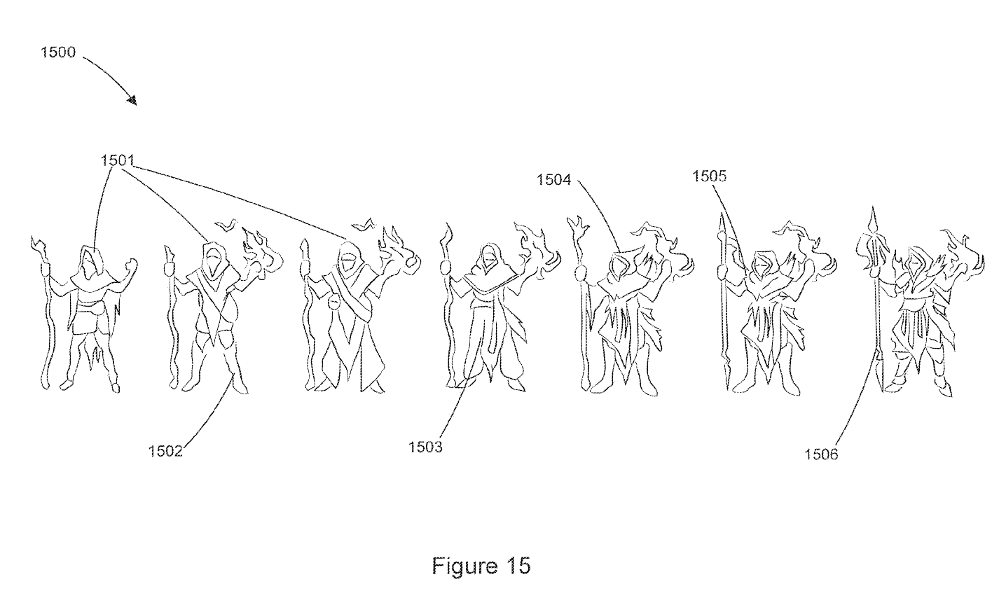

The feature game may be a game of chance that allows a player to collect or progress one or more player objects based on the non-monetary rewards won in the meta-game. According to some embodiments, the feature game may be a progression type game, where non-monetary rewards allow a player to progress a player object or other symbolic representation through stages. An example display of a progression type feature game is shown in FIG. 13. According to some embodiments, the feature game may be a collection type game, where non-monetary rewards allow a player to collect player objects or other symbolic representations to add to a collection. An example display of a collection type feature game is shown in FIG. 14. According to some embodiments, the feature game may be a hybrid progression and collection type game, where non-monetary rewards allow a player to collect player objects or other symbolic representations to add to a collection, and to progress the player objects or other symbolic representations through stages, for example. An example display of a hybrid progression and collection type feature game is shown in FIG. 15.

The rules basis and paradigm for determining a winning outcome in the meta-game may be different from the rules and paradigm to determine a winning outcome in the base game. For example, a winning outcome in the meta-game may be due to the appearance of one or more symbols of a predetermined subset of symbols among the randomly generated symbol subset, without necessarily relying on a combination of symbols being present in the symbol subset. Further, a winning outcome in the meta-game may be due to the appearance of a symbol combination among the randomly generated symbol subset either along a payline, being a predetermined linear sequence of symbols, or randomly throughout the displayed symbols. According to some embodiments, a winning outcome may also require one or more predetermined symbols to appear on adjacent reel positions, or randomly across all reels. Executing meta-game module 412 may cause processor 202 to determine whether the player completed a meta-game task using meta-game pay-table data 403. According to some alternative embodiments, the rules basis and paradigm for determining a winning outcome in the meta-game may be the same as the rules and paradigm to determine a winning outcome in the base game, but may rely on a different set of symbol combinations predetermined as winning symbol combinations.

Feature game module 413 may be executable by processor 202 to cause a feature game to be shown on visual display unit 104. In some embodiments, the feature game may be a chance based game that allows a player to progress through stages based on the completion of meta-game tasks. For example, the object of the game may be to build a castle, collect a set of cards, collect a set of figurines, or another object. In some embodiments, feature game module 413 may cause a virtual location to be shown on visual display unit 104 based on feature game map data 407. Player objects displayed for the player to collect or build upon may be related to the virtual location. In some embodiments, the player may be awarded with monetary and/or non-monetary prizes for completing objects of the feature game.

Player object generation module 414 may be executable by processor 202 to cause one or more player objects to be generated and displayed on gaming machine 100 for selection and/or modification by a player. In some embodiments, player object generation may include generating a single player object for the player, where the player object can be modified during the course of the game. According to some embodiments, player object generation may include generating multiple player objects that a player can collect. Generated player object data may be stored in character data 405.

Virtual location generation module 415 may be executed by processor 202 to cause one or more virtual locations to be generated and displayed on gaming machine 100 for selection by a player. In some embodiments, the one or more virtual locations may be displayed on a map. The virtual locations may be generated based on virtual location data 406.

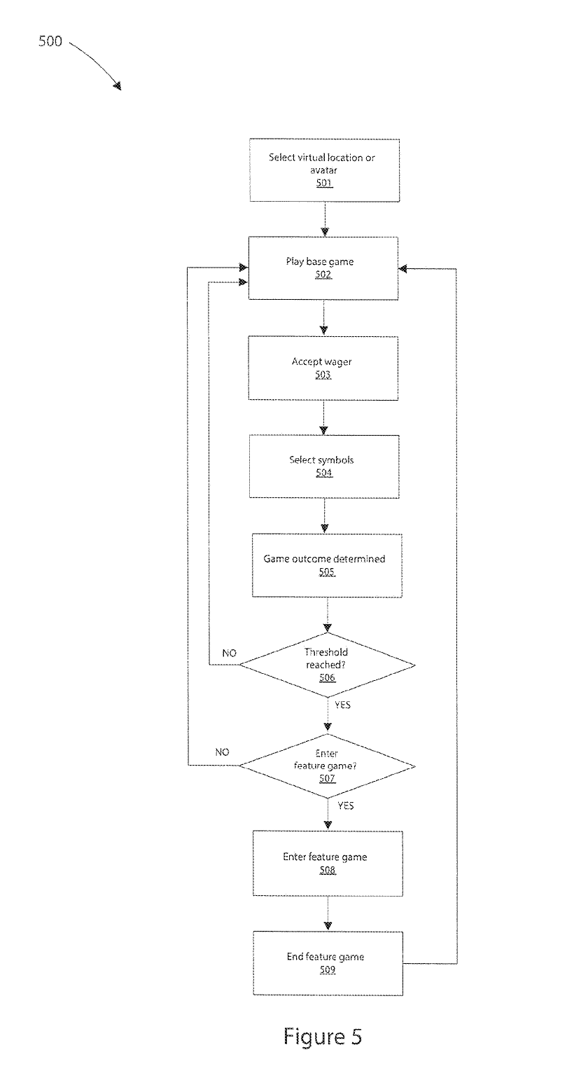

Referring now to FIG. 5, there is shown a flow diagram illustrating a method 500 of gaming by implementing a game at a gaming system, such as gaming machine 100 illustrated in FIG. 1 and gaming machines 304 illustrated in FIG. 3.

The method 500 of gaming may comprise an initial step 501 of a player providing credit at credit input mechanism 221 of the gaming machine 100, and selecting a virtual location and/or player object for game play. Processor 202 may execute virtual location generation module 415 and/or player object generation module 414, which may read from player object data 405 and virtual location data 406, respectively. A player object or location may be selected by scrolling through a series of available player objects and locations on the touchscreen display of gaming machine 100. For example, the selectable locations may include a forest, desert, castle, and/or swamp in some embodiments. Virtual game play locations may be tailored to a general theme of the game. In some embodiments, the selection of the player object may determine the virtual game play starting location. For example, where an avatar is used as a player object, selecting a knight character may result in game play beginning in a virtual castle, while selecting an elf may result in game play in a virtual forest, and selecting a troll may result in game play beginning in a virtual swamp.

At step 502, a base game is implemented on gaming machine 100 by processor 202 executing base game module 411. In some embodiments, the base game may be a reel game, which may be generated using symbol data 401. In some embodiments, the base game may be a different chance based game in which symbols are randomly selected from a symbol set for display on visual display unit 104, without the appearance of spinning reels.

At step 503, a player places a bet and causes an instance of base game module 411 to be initiated by processor 202, through interaction with user input 118. Some of the amount bet by the player may be placed into a prize pool. Some of the wager may also be kept by the house, being the business or establishment that owns and/or controls gaming machines 100/304. The amount kept by the house may be varied based on the regulatory rules in the jurisdiction the game is being played in.

As the base game is initiated, processor 202 may also initiate meta-game module 412 based on meta-game task data 404. The meta-game may comprise a series of tasks to be completed by the player in order to allow a player to progress toward receiving an aesthetic item or a game influencing item, or may allow for the direct award of non-monetary prizes such as aesthetic and game influencing items to the player. Progress and completion of any tasks may be determined based on outcomes of the base game as determined with reference to meta-game pay-table data 403.

At step 504, base game module 411 is executed by processor 202 to cause a plurality of symbols derived from symbol data 401 to be selected by processor 202 for display at a plurality of display positions on a visual display unit 104. In some embodiments, where the base game is a reel game, base game module 411 may be executed by processor 202 to cause the reels to appear to virtually spin on visual display unit 104. The selection of the symbols may be performed randomly, for example by the random number generator 414.

In a further step 505, a game outcome is determined based on the randomly displayed symbols on the display. The game outcome may consist of a base game outcome, determined by processor 202 based on base game pay-table data 402, and a meta-game outcome determined by processor 202 based on meta-game pay-table data 403. The base game outcome may result in the awarding of a monetary prize to the player, based on the particular combination of symbols displayed. If a base game outcome results in the winning of a monetary reward, this may be credited to the player immediately in some embodiments through payout mechanism 225. In some other embodiments, the amount won may be stored and accumulated during the game session, and the total amount may be awarded at the end of the game session. The amount won may be taken out of the base game prize pool. The amount won may be awarded as cash, or as credits that can be redeemed for cash.

The meta-game outcome may allow the player to progress towards and/or complete one or more tasks or quests set in the meta-game, as determined by meta-game module 412 based on meta-game task data 404. The progress made toward the completion of each task may be displayed to the player in the form of a fraction, percentage, progress bar, or other means of showing the advancement through the task. If the meta-game outcome results in the completion of all of the set tasks, the player level as stored in player object data 405 may be increased. This may result in the player object changing appearance, or in an additional player object being awarded to the player. According to some embodiments, the awards available to a player on completion of the meta-game task may be a predetermined selection of awards. The actual award granted to the player may be determined based on a set of award rules, or may be randomised in some embodiments. In some embodiments the award may be randomly selected from a subset of awards determined based on a set of award rules.

In some embodiments, the meta-game outcome may alternatively or in addition allow a player to achieve other rewards. This may be on the completion of all tasks within a quest, each time a task is completed, or simply based on the combination of symbols displayed during the game. In some embodiments, the meta-game outcome may allow a player to win a non-monetary reward, such as an aesthetic reward that they can apply to their player object. According to some embodiments, where the player object is an avatar, the aesthetic rewards may include items of clothing, accessories, or the ability to change the hairstyle, hair colour, eye colour, or other elements of the appearance of their player object. Where the player object is a house or vehicle, the aesthetic rewards may include furniture, paint jobs, interior design features, wheels, and other elements of the appearance of the player object.

In some embodiments, the meta-game may also allow a player to win one or more units of an in-game virtual currency as a form of non-monetary reward, which the player may later be able to use to purchase an aesthetic reward. For example, a game may allow a player to win in-game credits, coins, jewels, tokens, or another form of virtual currency. Different aesthetic rewards may be able to be virtually purchased, and may each cost a different amount. For example, a cloak may cost 3 coins of in-game currency, a and a pair of boots may cost 10 coins of in-game currency, in some embodiments. In some embodiments, the in-game currency is not transferrable for real currency or monetary credits that can be redeemed for real currency.

At step 506, processor 202 may determine whether a threshold has been reached that allows for entry into a feature game. In some embodiments, the entry to the feature game may be by a predetermined symbol combination appearing on the reels. In some alternative embodiments, entry to the feature game may be based on reaching a time-based threshold (that the player has been playing the game for at least 5 minutes, 10 minutes, 15 minutes, 20 minutes, 25 minutes or 30 minutes, for example), a spend based threshold (that the player has spent a particular amount of money) or a games played threshold (that the player has played a particular number of base games). Multiple different threshold conditions may be applied in combination. In some embodiments, entry to a feature game may be semi-randomised after the threshold condition has been met, for example where the entry is selected at random from a range in addition to or on top of the threshold. For example, for a given base spend threshold, such as 100 credits, entry into the feature game may occur at a randomly selected time between 5 minutes and 10 minutes after reaching the base spend threshold.

If the threshold has not been reached, game play returns to step 502, with processor 202 causing base game module 411 to re-initiate and the player having a further opportunity to place a wager and play the base game.

If the threshold has been reached, at step 507 the player is given the opportunity to enter the feature game. If the player chooses not to enter the feature game, which may be to allow themselves time to meet more meta-game objectives, for example, the play returns to step 502, with processor 202 causing base game module 411 to re-initiate and the player having a further opportunity to place a wager and play the base game. In some embodiments, the player may be forced to enter the feature game after a predetermined limit has been reached. For example, the player may be forced to enter the feature game after a predetermined amount of time, after a predetermined number of base games have been played, once the player's object reaches a predetermined level, or after the player has spent a predetermined amount of money or credits, for example.

If the player chooses to enter the feature game, the feature game is initiated at step 508 by processor 202 executing feature game module 413. The feature game may be a chance-based game in some embodiments. The feature game may allow a player to display one or more player objects, and build upon or modify their player objects based on their results in the meta-game.

The feature game may run until a predetermined threshold is reached at step 509. This may be a time-based threshold, or an achievement based threshold, for example. Once this is reached, the game will be directed back to the base game at step 502 by processor 202 re-initiating base game module 411. According to some embodiments, a player may be awarded a number of free feature game plays, and the feature game will end once the player has played the determined number of free games. According to some embodiments, during play of the feature game, the player may be awarded further free games based on a chance-based event occurrence in the free game.

In some embodiments, the player may be able to end the game session at any point during gameplay. When the player ends the game session, any accumulated winnings may be paid out to the player, in the form of cash or credits using payout mechanism 225. In some embodiments, gaming machine 100 may also issue a ticket corresponding to the player's objects in the game. For example, the ticket may store an identification number corresponding to an entry in a look-up table that stores data relating to the player object. The ticket may allow a player to load the player object into the game at that player's next gaming session. In some embodiments, the player may be able to use the ticket to upload their player object into an online gaming environment. Players may also be able to transfer any unused in-game currency to the new game.

In some embodiments, instead of a ticket, player object data may be stored in another form, such as using a QR code, smart card, magnetic stripe card, near field transfer, or another electronic or non-electronic means of data storage, that the player can use to store their player object data to load their player object into the game at their next gaming session.

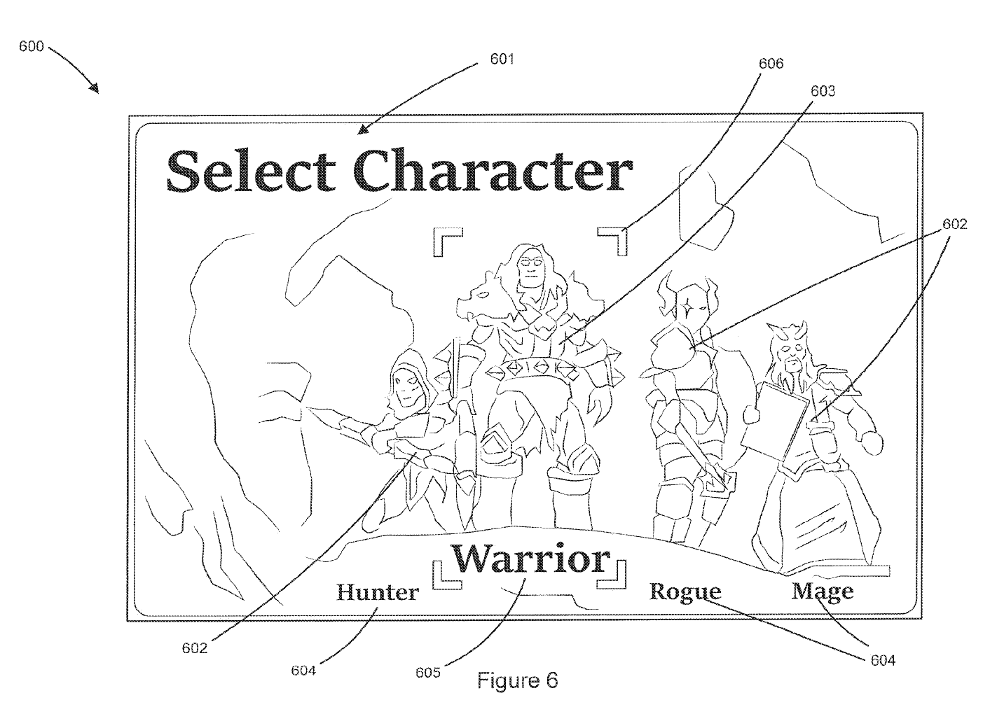

A specific example of the method 500 of gaming is described below with reference to screenshots of different displays or display components of the gaming system 100 shown in FIGS. 6 to 15.

FIG. 6 is an example screenshot of an avatar selection screen 600 of gaming machine 100, where the player object in the game displayed is an avatar. Avatar selection screen 600 may be generated by player object generation module 414 based on information read by processor 202 from player object data 405. Screen 600 shows a message 601 instructing a player of gaming machine 100 to select a character or avatar. A number of avatars 602 may be displayed for selection. Each avatar has an avatar type descriptor 604 (such as warrior, hunter, rogue or mage, for example). The player may scroll through the avatars using user input 218. As the player scrolls through the available avatars 602, one avatar may appear as the “selected” avatar 603 at any given time. The selected avatar 603 is shown as being in front of unselected avatars 602, and is shown highlighted by virtual markings 606. The name of the selected avatar 605 may appear bigger, in a different colour, or otherwise distinguishable from the names of the unselected avatars 604. Once the player has scrolled to their desired avatar, they may use user input 218 to confirm their selection and exit avatar selection screen 600.

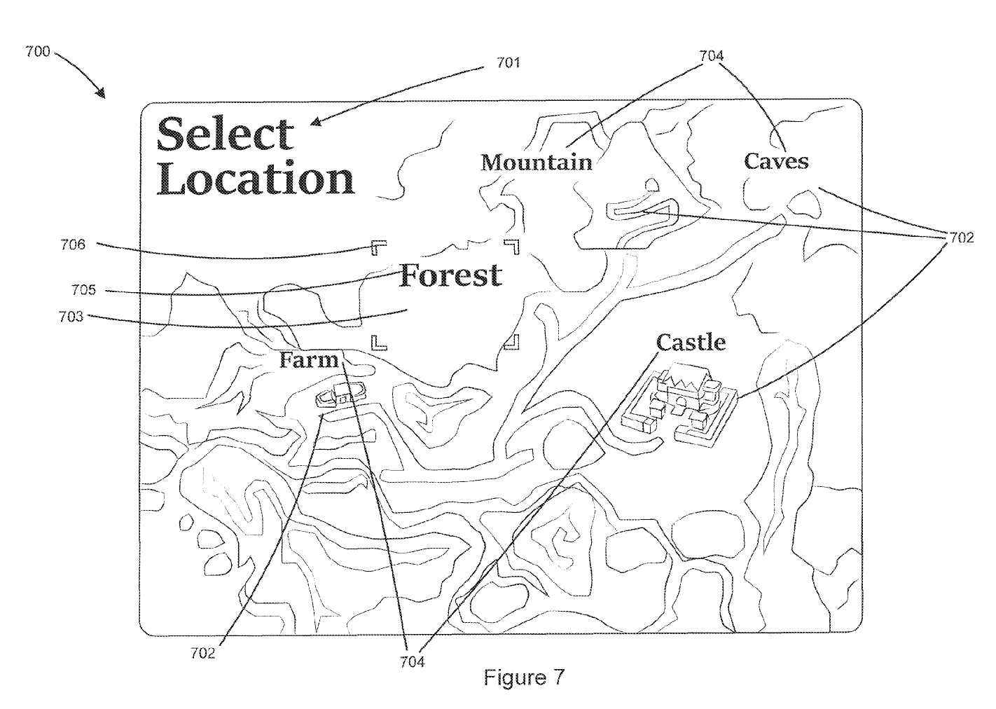

FIG. 7 is an example screenshot of a virtual location selection screen 700 of gaming machine 100, as generated by virtual location generation module 415 based on information read by processor 202 from virtual location data 406. Screen 700 displays a message 701 instructing a player of gaming machine 100 to select a location. A number of locations 702 are displayed for selection. Each location has a location name or descriptor 704. The player may be able to scroll through the locations using user input 218. As the player scrolls through the available locations 702, one location may appear as the “selected” location 703 at any given time. The selected location is shown highlighted by virtual markings 706. The name of the selected location 705 may appear bigger, in a different colour, or otherwise distinguishable from the names of the unselected locations 704. Once the player has scrolled to their desired location, they may use user input 218 to confirm their selection and exit the location selection page.

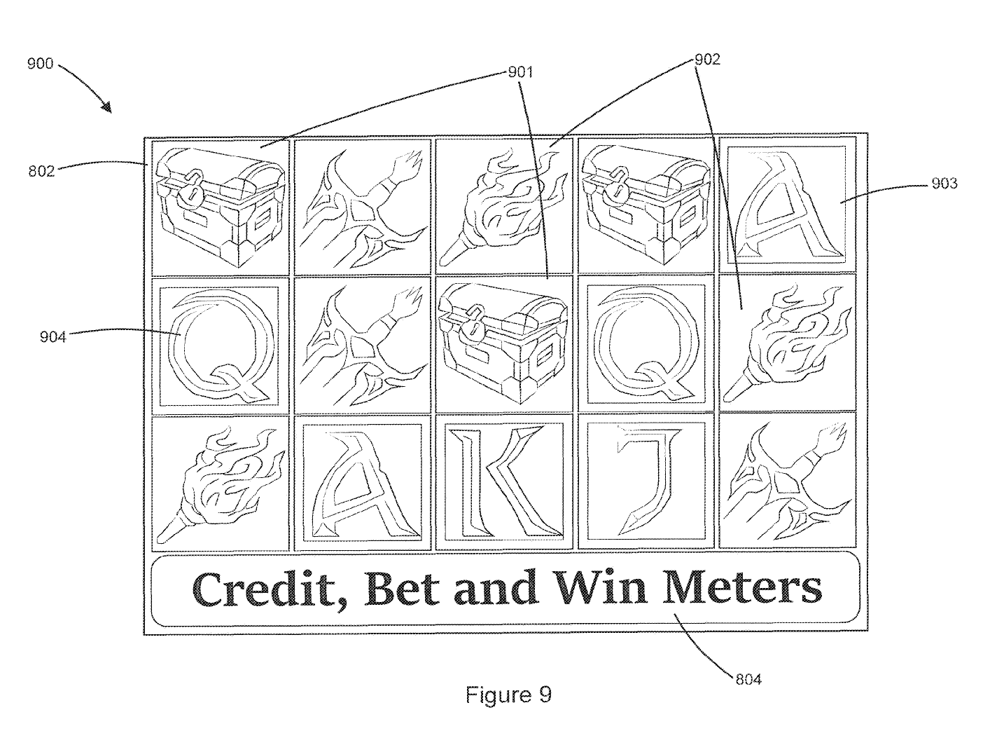

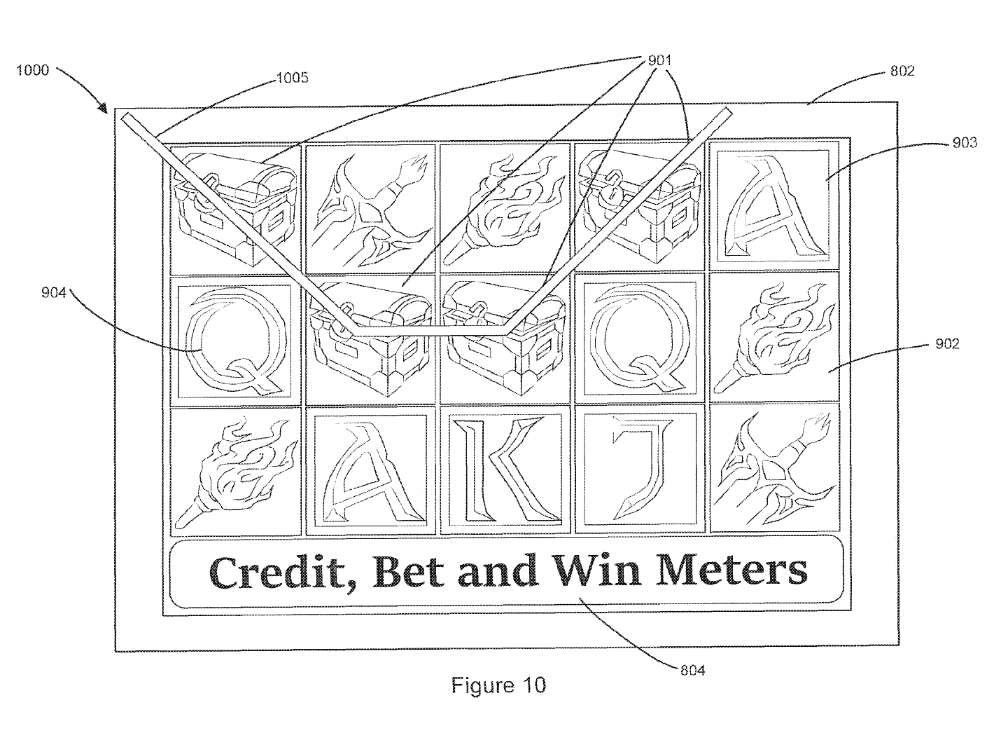

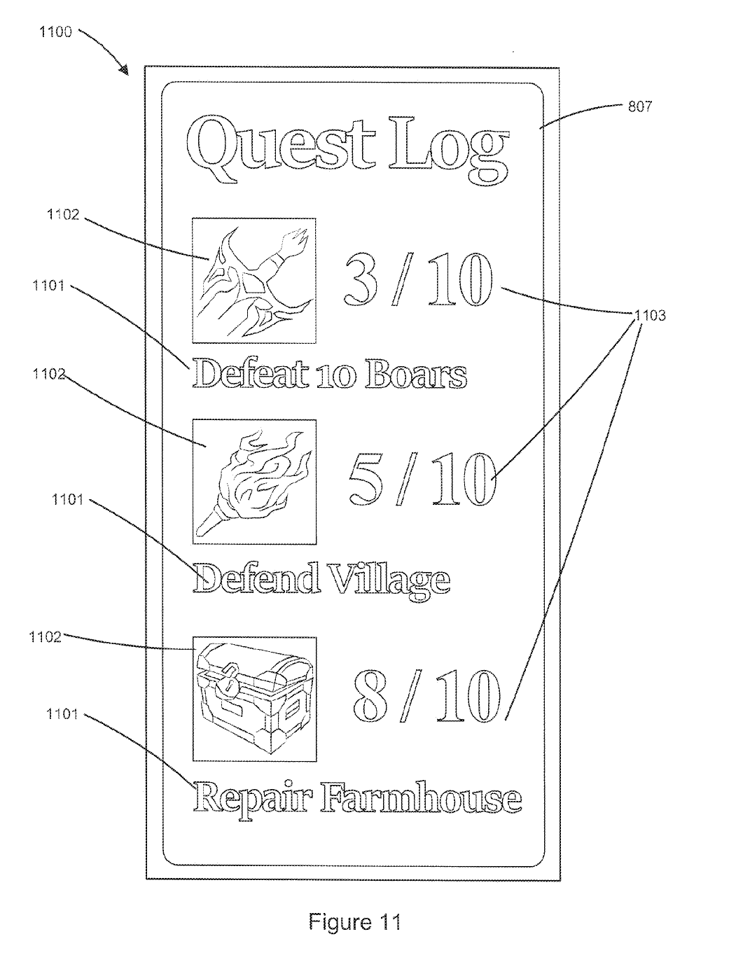

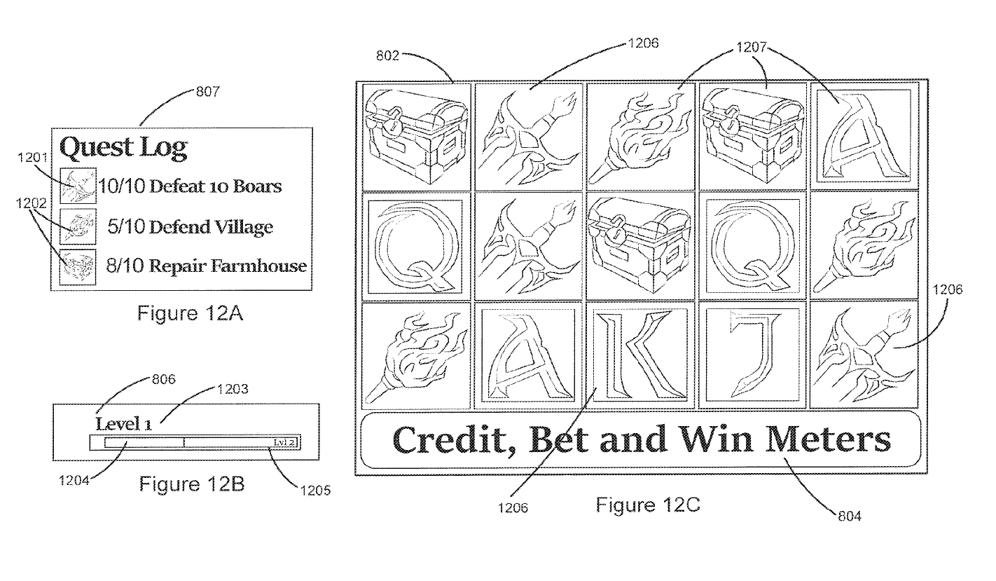

FIG. 8 is an example screenshot of a base game screen 800 of gaming machine 100, as generated by base game module 411 based on information read by processor 202 from symbol data 401. Screen 800 displays a game title 801 and symbol sets 802 for a base game. Symbol sets 802 are described in further detail below with reference to FIGS. 9 and 10. Screen 800 also displays a selected avatar 803, and credit, bet and win meters 804 which may display an amount of credit that a player has, an amount bet, and an amount won in a particular gaming session. Selected avatar 803 may be an avatar selected by the player using avatar selection screen 600. Screen 800 may have a map selection virtual button 805, which may be used to go back to virtual location selection screen 700. Screen 800 also shows level indicator 806 and quest log 807. Level indicator 806 and quest log 807 are described in further detail below with reference to FIGS. 11 to 12C.

FIG. 9 is a detailed view 900 of symbol sets 802. Symbol sets 802 display a number of symbols as generated by processor 202 based on symbol data 401. The symbols may include pictorial symbols, such as treasure chest symbol 901, torch symbol 902, and sword symbol 905 as well as alphanumeric symbols, such as A symbol 903 and Q symbol 904. In some embodiments, the alphanumeric symbols may correspond to cards from a standard deck of cards, such as Ace and Queen for A and Q respectively. The symbol sets 802 displayed may be used by processor 202 to determine whether a monetary and/or non-monetary prize should be awarded, by comparing the symbols displayed with those in base game pay-table data 402 and meta-game pay-table data 403.

An example base game pay table is shown below, where each of the amounts shown in the table may correspond to credits that will be won by the player based on the appearance of the predetermined symbol combination (which commonly comprises multiple appearances of the same symbol).

Number of Symbols required

| Symbol | 5x | 4x | 3x | 2x |
|---|---|---|---|---|
| WC | | | | |
| PIC1 | 1,000 | 500 | 100 | 5 |
| PIC2 | 500 | 200 | 10 | 2 |
| PIC3 | 250 | 100 | 10 | |
| PIC4 | 200 | 80 | 10 | |
| A | 200 | 50 | 10 | |
| K | 200 | 50 | 10 | |
| Q | 150 | 20 | 10 | |
| J | 150 | 20 | 10 | |
| 10 | 100 | 15 | 5 | |
| 9 | 100 | 15 | 5 | 2 |
| SCAT | 100 | 20 | 5 | 2 |

According to some embodiments, PIC1 may be treasure chest symbol 901, PIC2 may be torch symbol 902, PIC3 may be sword symbol 905 and PIC4 may be a shield symbol (not shown), for example.

An example meta pay-table for non-monetary prizes that may be awarded during the meta-game based on the overlay symbols is shown below:

| | Number of Symbols | | |
|---|---|---|---|
| Symbol | 5x | 4x | 3x |
| J | 10-15 Fragments | 5-10 Fragments | 1-5 Fragments |
| | 150-200 Gold | 100-150 Gold | 20-100 Gold |
| | 3 Bronze Quest | 2 Bronze Quest | 1 Bronze Quest |
| | Ticks | Ticks | Tick |
| Q | 2x Discards | 1x Discards | 1x Discards |
| | 150-200 Gold | 100-150 Gold | 20-100 Gold |
| | 3 Silver Quest Ticks | 2 Silver Quest Ticks | 1 Silver Quest Tick |
| K | Skill Card (Rare) | Skill Card | Skill Card |
| | | (standard) | (standard) |
| | 300-500 Gold | 250-300 Gold | 200-250 Gold |
| | 3 Gold Quest Ticks | 2 Gold Quest Ticks | 1 Gold Quest Tick |

The table shows both direct non-monetary prizes (e.g. an amount of gold, or a skill card) as well as meta-game progress awards (e.g. gold quest ticks) that may be awarded based on a particular combination of symbols appearing during the chance based game.

According to some embodiments, meta-game task data 404 may store relationships between the meta-game progress awards and the non-monetary rewards that may be awarded to a player on completion of a quest. One example of a set of meta-game task data 404 is shown below:

| Quest | Requirement | Reward |
|---|---|---|
| A | 15 Bronze Quest Ticks | 300 Gold, 1 Fragment |
| B | 30 Bronze Quest Ticks | 400 Gold, 1 Fragment |
| C | 15 Silver Quest Ticks | 7500 Gold, 1 Discard |
| D | 15 Gold Quest Ticks | 2x Skill Cards |
| E | 50 Bronze Quest Ticks | 3x Skill Cards, 1500 Gold |

An alternative example meta-game pay-table is described below with reference to FIG. 17.

FIG. 10 is an example screenshot of a base game screen 1000 of gaming machine 100 showing a winning pay-line 1005 as determined by processor 202 based on base game pay-table data 402. The winning pay-line may appear on symbol sets 802 when the player of gaming machine 100 places a bet and causes symbol sets 802 to generate a set of symbols for display. Four treasure chest symbols 901 are shown intersecting the winning pay-line 1005. The remaining symbols, including symbols 902, 903 and 904 are shown not intersecting the winning pay-line. The winning pay-line may result in the player winning an amount of cash, credits, or other awards from gaming machine 100. In some embodiments the winning pay-line 1005 may also result in progress in the meta-game as described in further detail below with reference to FIGS. 11 to 12C, or in the reward of non-monetary prizes, based on meta-game pay table data 403.

FIG. 11 is a detailed view 1100 of quest log 807. Quest log 807 tracks a players progression through a meta-game, as controlled by meta-game module 412 based on information from meta-game task data 404, during the play of the base game displayed on symbol sets 802. Quest log 807 shows a number of quests 1101, described as tasks to be completed during the meta-game. The tasks may be tailored to the character, the game scenario and/or the virtual location of the game selected by the player. For example, if a farm location is selected, tasks may include “Defeat 10 boars”, “Defend village”, and “Repair farmhouse”, for example. Each task may be displayed next to a symbol 1102. In some embodiments, the symbols displayed may correspond to symbols of the symbol sets 802, and may be related to the symbols that need to appear on symbol sets 802 in order to complete the tasks. Meta-game pay table data 403 may be used to determine whether a particular symbol combination contributes to progress in a meta-game task.

The tasks or quests may include a progress meter 1103, which may show how many more successful symbol appearances are required until the task is completed. Processor 202 may determine what amounts to a successful symbol appearance based on meta-game pay-table data 403. For example, in the illustrated embodiment, each task requires 10 successful symbol appearances to become completed. The “Defend 10 Boars” task has been completed 3 times out of a required 10 times. The “Defend village” and “Repair farmhouse” tasks have been completed 5 and 8 times out of a required 10 times, respectively. In some embodiments, once each or all of the quests have been completed, the player's avatar may be caused to change appearance or acquire new aesthetic items, or the player may receive a new player object to add to their player object collection.

FIG. 12A is a detailed view of quest log 807, showing a task being completed. The “Defeat 10 boars” task 1201 is highlighted, as 10 of the 10 required successful symbol appearances have been achieved. Incomplete tasks 1202 are not highlighted. According to some embodiments, a player may be able to access a prize table or in-game rule screen to see which symbol combinations they require to complete each displayed task.

FIG. 12B is a detailed view of level indicator 806. Level indicator 806 shows a current level 1203 of the player's avatar, which is Level 1 in the illustrated embodiments. Level indicator 806 also shows a progress bar 1204, showing how much more progress is required in the meta-game and/or in the feature game before the character reaches the next level. Level indicator 806 also displays the next level 1205 for the character to achieve. As the player's avatar increases in level, the appearance of the avatar may change, and the avatar may acquire new aesthetic items.

FIG. 12C shows an example screenshot of symbol sets 802 showing a winning combination of symbols 1206 as determined by processor 202 based on meta-game pay-table data 403, highlighting a winning meta-game combination. Symbols that are not part of the winning combination, such as symbols 1207, are not highlighted. Based on the combination of symbols that appear on symbol sets 802, processor 202 determines, based on meta-game pay-table data 403, whether the symbol combinations are winning combinations. A winning combination may result in one or more tasks 1101 (i.e. meta-game objectives) being completed in some embodiments, or progress being made towards the completion of one or more tasks. In some embodiments, a winning combination may result in the direct award of in-game currency, aesthetic rewards or new player objects.

FIG. 13 is an example screenshot of a feature game screen 1300 of gaming machine 100. Screen 1300 is an example of a progression type feature game, where the player object includes a house or dwelling. When beginning a gaming session, a player may be allocated or asked to select an initial dwelling, which may be a rudimentary or primitive dwelling like a tent, tepee, or hut. As the player object level increases, the player may be able to upgrade their dwelling. According to some embodiments, the player objects or other symbolic representations may upgrade automatically according to predefined game rules as the player object level progresses. For example, in FIG. 13, a level indicator 1301 shows the levels that can be achieved by the player object. In the illustrated embodiments, the player object starts at level 1, and can proceed through to level 20. Once the player object reaches the highest level, a monetary or non-monetary reward may be awarded to the player. Level 1 corresponds to a tent 1302. Once the player object reaches level 5, the tent is upgraded to a house 1303. At level 15, the house is upgraded to a mansion 1304. At level 20, the mansion is upgraded to a castle 1305.

In some alternative embodiments, the achievement of meta-game tasks may allow a player to select which upgrades to apply to the player object. For example, according to some embodiments the player may be given the option to replace a straw roof with tiles, upgrade a timber fence to a brick fence, or construct a moat, for example. According to some embodiments, a player may be able to buy upgrades using virtual currency earned during the meta-game.

FIG. 14 is an example screenshot of a feature game screen 1400 of gaming machine 100. Screen 1400 is an example of a collection type feature game, where the player gathers a collection of player objects, being virtual cards. When beginning a gaming session, a player may be allocated or be able to select a random card, which the player may designate as their player object. As the player completes tasks in the meta-game, the player may be rewarded with additional cards to add to their collection. According to some embodiments, the player may be able to select which card from multiple different cards to add to the player's virtual card collection. According to some embodiments, the player may be rewarded with a monetary or non-monetary prize if they collect a full set of cards of a particular type, or a full set of all the available cards.

Screenshot 1400 shows three example cards that may be offered to a player, being a Wickman card 1401, a Fire Wizard card 1405, and a Lightning Demon card 1411. The cards may have symbols 1402, 1407 and 1412 indicating a value of the card. In the illustrated example, cards 1401 and 1405 have a value of 5, while card 1411 has a value of 8. These values may represent a level or prestige of the card. The cards may also have a designated type, which may be illustrated by card type symbols 1404, 1409 and 1414. In the illustrated example, cards 1401 and 1405 are Wizard type cards, while card 1411 is a Demon type card. A sub-class of the card may be illustrated by symbols 1405, 1410 and 1415. The cards display illustrations 1403, 1408 and 1413 which may correlate to the card type and value in some embodiments.

FIG. 15 is an example screenshot of a feature game screen 1500 of gaming machine 100. Screen 1500 is an example of a hybrid type feature game, where the player objects are a collection of characters who can be upgrades or have aesthetic items added to them. When beginning a game session, a player may select or have allocated to them a character. As the player completes meta-game tasks, they may be able to upgrade player objects they have in their collection, as well as collecting further player objects to add to their collection.

Screenshot 1500 shows a number of player objects 1501 that have been upgraded in different ways and that have different aesthetic items applied to them. As a player completes meta-game tasks, they may be given the option of which aesthetic items to add to their player objects. For example, they may be able to add boots 1502, a tunic 1503, a hood 1504, armour 1505 and/or a staff 1506 to their player object. Players may be awarded monetary or non-monetary prizes when they collect a set of player objects, or when one or more of their player objects achieve a particular level.

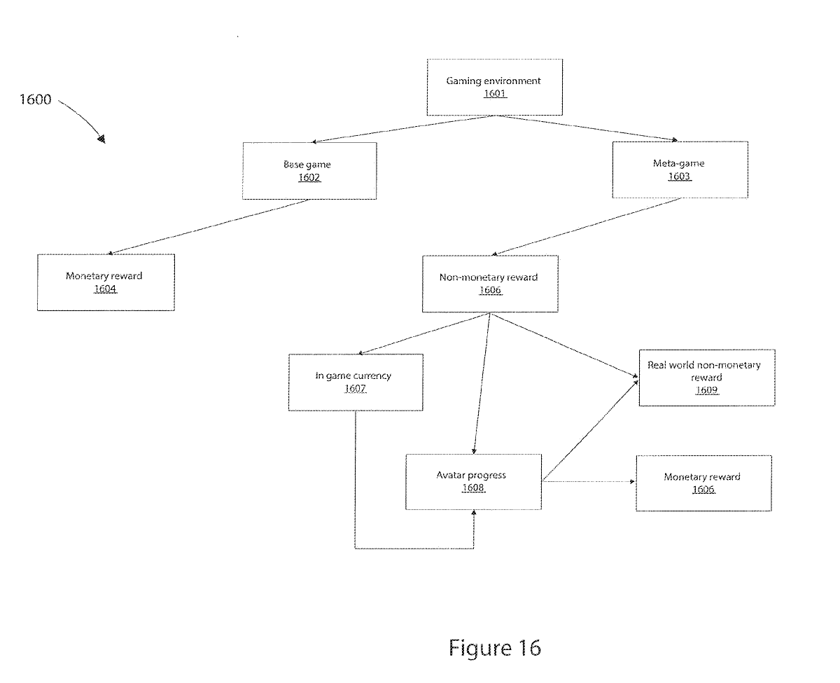

FIG. 16 shows a chart 1600 of the various pathways for winning monetary and non-monetary prizes via a gaming environment 1601 presented on gaming machine 100/300. According to some embodiments, from gaming environment 1601, a player can play both a base game 1602 and a meta-game 1603. According to some embodiments, the base game and the meta-game may be played simultaneously. Base game 1602 may allow a player to win monetary rewards 1604 based on the outcome of the game through base game pay-table data 403, as described above with reference to FIG. 8. Meta-game 1603 may also allow a player to make win non-monetary rewards 1606, based on meta-game pay-table data 403, as described below with reference to FIG. 17. Non-monetary rewards 1606 may include in-game currency 1607, player object progress 1608 and real world non-monetary rewards, such as products or experiences. In game currency 1607 may be used by a player to purchase player object progress 1608, such as additional player objects to add to a player's collection, or aesthetic items to modify an existing player object.

FIG. 17 is an example screenshot of a base game screen 1700 of gaming machine 100, as generated by base game module 411 based on information read by processor 202 from symbol data 401. Screen 1700 displays a symbol set 802 for a base game, as described in further detail above with reference to FIGS. 8 to 10. Screen 1700 also displays a selected avatar 803, and credit, bet and win meters 804 which may display an amount of credit that a player has, an amount bet, and an amount won in a particular gaming session. Selected avatar 803 may be an avatar selected by the player using avatar selection screen 600, as shown in FIG. 6. Screen 1700 also shows level indicator 806, which shows a current level (being level 19 in the illustrated embodiment) along with a bar graph showing the level of progress to the next level (being level 20 in the illustrated embodiment). Level indicator 806 is described in further detail above with reference to FIGS. 11 to 12C.

FIG. 17 shows the avatar name, level and type in avatar summary 1705. In the illustrated embodiment, the avatar is a level 19 mage, and the avatar name is Mortimer Finn. The avatar name may be selected by the player, randomly generated, or tied to the player type.

FIG. 17 shows a number of overlay symbols 1702, 1703 and 1704 that may be used to determine the results of a meta-game based on meta-game pay-table data 403. In the illustrated embodiment, overlay symbols include gold stars 1702, silver stars 1703 and bronze stars 1704. According to some embodiments, the appearance and arrangement of the overlay symbols may be used to determine the outcome of the meta-game. The outcome may be determined based on the position of the overlay symbols with respect to one another, and/or the position of the overlay symbols with respect to symbol sets 802.

An example pay-table for non-monetary prizes that may be awarded during the meta-game based on the overlay symbols is shown below:

| | Number of Symbols | | |
|---|---|---|---|
| Symbol | 5x | 4x | 3x |
| Bronze Star | 10-15 Fragments | 5-10 Fragments | 1-5 Fragments |
| | 150-200 Gold | 100-150 Gold | 20-100 Gold |
| | 3 Bronze Quest | 2 Bronze Quest | 1 Bronze Quest |
| | Ticks | Ticks | Tick |
| Silver Star | 2x Discards | 1x Discards | 1x Discards |
| | 150-200 Gold | 100-150 Gold | 20-100 Gold |
| | 3 Silver Quest Ticks | 2 Silver Quest Ticks | 1 Silver Quest |
| | | | Tick |
| Gold Star | Skill Card (Rare) | Skill Card | Skill Card |
| | | (standard) | (standard) |
| | 300-500 Gold | 250-300 Gold | 200-250 Gold |
| | 3 Gold Quest Ticks | 2 Gold Quest Ticks | 1 Gold Quest |
| | | | Tick |

The table shows both direct non-monetary prizes (e.g. an amount of in-game currency (gold), or a skill card) as well as meta-game progress awards (e.g. gold quest ticks) that may be awarded based on a particular combination of overlay symbols appearing during the chance based game.

According to some embodiments, meta-game task data 404 may store relationships between the meta-game progress awards and the non-monetary rewards that may be awarded to a player on completion of a quest. One example of a set of meta-game task data 404 is shown below:

| Quest | Requirement | Reward |
|---|---|---|
| A | 15 Bronze Quest Ticks | 300 Gold, 1 Fragment |
| B | 30 Bronze Quest Ticks | 400 Gold, 1 Fragment |
| C | 15 Silver Quest Ticks | 7500 Gold, 1 Discard |
| D | 15 Gold Quest Ticks | 2x Skill Cards |
| E | 50 Bronze Quest Ticks | 3x Skill Cards, 1500 Gold |

FIG. 18 shows a graph 1800 illustrating an example probability distribution that may be implemented by gaming machine 100 to balance the probabilities of a player receiving monetary and non-monetary prizes, as described above. Non-monetary axis 1801 shows the probability distribution for winning or not winning non-monetary prizes, based on win section 1802 and loss section 1803. Monetary axis 1804 shows the probability distribution for winning or not winning monetary prizes, based on win section 1805 and loss section 1806. Sections 1802, 1803, 1805 and 1806 divide graph 1800 into areas 1807, 1808, 1809 and 1810. Area 1807 corresponds to the probability distribution of a player winning both a monetary and a non-monetary prize. Area 1808 corresponds to the probability distribution of a player winning a monetary prize, but not winning a non-monetary prize. Area 1809 corresponds to the probability distribution of a player winning a non-monetary prize, but not a monetary prize. Area 1810 corresponds to the probability distribution of a player winning neither a monetary nor a non-monetary prize.

Areas 1807 and 1808 correspond to monetary wins for the player, which increase player satisfaction, but require gaming machine 100 to award a monetary reward from a prize pool. The ratio between winning outcomes and non-winning outcomes for monetary rewards must be balanced based on meeting the regulatory standards for a minimum return-to-player as well as ensuring that the gaming machine is profitable. In gaming machines with only monetary rewards, this may result in players feeling like they do not win often enough, causing dissatisfaction with the game. However, gaming machine 100 or 300 is configured to also allow for non-monetary rewards to be won in the context of a hybrid gaming environment, allowing player satisfaction to be increased while not affecting the profitability of the gaming machine. Areas 1807 and 1809 of graph 1800 correspond to non-monetary wins for the player, which increase player satisfaction, but do not require gaming machine 100 to award a monetary reward from a prize pool.

Probability distribution 1811 of graph 1800 is an example of a probability distribution of game outcomes over time on gaming machine 100 or 300 that may be implemented by base game pay table data 402 and meta-game pay table data 403. Probability distribution 1811 defines an inverse relationship between the awarding of non-monetary prizes and monetary prizes, so that a player is most likely to either win a monetary prize but not a non-monetary prize, or a non-monetary prize but not a monetary prize, as shown by the large intersections between areas 1808 and 1809 with probability distribution 1811. Players are less likely to win both a monetary prize and a non-monetary prize, or to win neither a monetary nor a non-monetary prize, as shown by the small intersection between areas 1807 and 1810 with probability distribution 1811. As seen in graph 1800, there is a relatively low probability that a player wins nothing, as shown by the intersection between area 1810 and probability distribution 1811, which results in a game where the player is likely to feel that they are successful, and will wish to continue playing.

Probability distribution 1811 shown in graph 1800 is only one example of a distribution that may be implemented by gaming machine 100 or 300, and the exact shape and size of probability distribution 1811 may be varied to alter the probabilities of a player winning monetary and non-monetary prizes. For example, if probability distribution 1811 were to take up the whole graph 1800, the probability of the player winning a monetary prize would be 50%, and the probability of the player winning a non-monetary prize would also be 50%, such that the probability of the player winning both a monetary prize and a non-monetary prize, or of winning neither prize, would be 25% each. In some embodiments, probability distribution 1811 may be shifted. If probability distribution 1811 is shifted to the left and up, a player may be more likely to win both a monetary prize and a non-monetary prize, and less likely to not win either prize. If probability distribution 1811 is shifted to the left and down, a player may be more likely to win a non-monetary prize, and less likely to win a monetary prize.

The size and shape of probability distribution 1811 may also be altered, such as by being more circular, or in a horse-shoe or U-shape, for example. Probability distribution 1811 need not be symmetrical or curved in shape, and may be a triangle, square, rectangular, or other shape. The exact shape and dimensions of probability distribution 1811 may be determined based on the desired operating characteristics of gaming machine 100. The intersection of probability distribution 1811 with monetary award-winning areas 1807 and 1808 may first be determined based on regulatory requirements, and a desired profitability of gaming machine 100 or 300. Subsequently, the intersection of probability distribution 1811 with non-monetary award-winning areas 1809 and 1810 may be determined to allow for a higher player satisfaction through the award of non-monetary prizes.

Certain steps in the processes or process flows described in this disclosure naturally precede others for the embodiments to function as described. However, embodiments are not limited to the order of the steps described if such order or sequence does not alter the functionality of the described embodiments. That is, it is recognized that some steps may performed before, after, or parallel (substantially simultaneously with) other steps without departing from the scope and spirit of the present disclosure. In some instances, certain steps may be omitted or not performed. Further, words such as “thereafter”, “then”, “next”, etc. are not intended to limit the order of the steps. These words are simply used to guide the reader through the description of the exemplary method.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

While the foregoing description has been provided by way of example of the preferred embodiments as presently contemplated, which utilise gaming machines of the type found in casinos, those skilled in the relevant arts will appreciate that described embodiments also may have application to internet gaming and/or have application to gaming over a telecommunications network, where mobile handsets are used to display game outcomes and receive player inputs. Such mobile devices include smart phones, notebooks, tablets, iPads and laptop computers. For instance free mobile device games may be offered for download and play on a player's personal mobile device as a bonus game play. In some embodiments, these downloads may be made available on a server accessible via an internet connection. In some embodiments, gaming machine 100/304 may comprise a communication interface to enable interaction and data transfer between the personal mobile devices and gaming machine 100/304, to allow downloads from gaming machine 100/304 to the personal mobile device. The communication interface may be a wireless interface in some embodiments.

Further embodiments may enable a player to upload the outcome of a game or bonus game to a social media site(s), post tournament scores etc.

1. A gaming machine for awarding monetary and non-monetary rewards, the gaming machine comprising:
a display;
a memory;
at least one input mechanism configured to receive user input from a player; and
a game controller configured to access and execute instructions stored in the memory to:
present at least one instance of at least one game of chance on the display;
generate a randomised game outcome for the at least one instance of the at least one game of chance;
access at least one non-monetary pay table;
determine a first winning event for the at least one instance of the game of chance;
access at least one monetary pay table;
determine a second winning event for the at least one instance of the game of chance;
based on the first winning event of the game of chance and the at least one non-monetary pay table, determine whether the player should be awarded a non-monetary reward; and
based on the second winning event of the game of chance and the at least one monetary pay table, determine whether the player should be awarded a monetary reward.

2. The gaming machine of claim 1, wherein the non-monetary reward contributes to progression in a chance based feature game.

3. The gaming machine of claim 2, wherein the feature game comprises modifying a player object.

4. The gaming machine of claim 2 or claim 3, wherein the feature game comprises collecting one or more player objects.

5. The gaming machine of any one of claims 2 to 4, wherein the non-monetary reward is an aesthetic item that affects the appearance of a player object in the chance based feature game.

6. The gaming machine of any one of claims 2 to 5, wherein the non-monetary reward includes at least one unit of in-game currency.

7. The gaming machine of claim 6, wherein in-game currency can be used to purchase an aesthetic item that affects the appearance of a player object in the chance based feature game.

8. The gaming machine of any one of claims 1 to 7, wherein the game controller is configured to determine whether the player should be awarded a non-monetary or monetary reward by comparing one or more symbols generated by the game of chance with the at least one non-monetary pay table and the at least one monetary pay table.

9. The gaming machine of any one of claims 1 to 8, wherein presenting the game of chance on the display involves presenting a plurality of symbols on the display.

10. The gaming machine of claim 9, wherein the first winning event is determined based on a first characteristic of the plurality of symbols and the second winning event is determined based on a second characteristic of the plurality of symbols.

11. The gaming machine of claim 9 or claim 10, wherein the first winning event is determined based on a first subset of the plurality of symbols and the second winning event is determined based on a second subset of the plurality of symbols.

12. The gaming machine of any one of claims 1 to 11, wherein the game of chance is a reel game.

13. The gaming machine of claim 12, wherein the awarding of a non-monetary award is determined based on whether one or more predetermined reel symbols appear on the reel game.

14. The gaming machine of claim 12 or claim 13, wherein the awarding of a monetary award is determined based on whether one or more predetermined reel symbols appear on the reel game.

15. The gaming machine of any one of claims 1 to 14, wherein the gaming machine is configured to award monetary and non-monetary prizes based on a predetermined probability distribution.

16. The gaming machine of claim 15, wherein the probability distribution creates an inverse relationship between the probabilities of winning a monetary prize and a non-monetary prize.

17. The gaming machine of claim 15 or claim 16, wherein the probability distribution creates a higher chance of winning only one of a monetary prize and a non-monetary prize compared to the chance of winning both of a monetary prize and a non-monetary prize or neither of a monetary prize nor a non-monetary prize.

18. The gaming machine of any one of claims 15 to 17, wherein the probability distribution creates a higher chance of winning at least one of a monetary prize and a non-monetary prize compared to the chance of winning neither a monetary prize nor a non-monetary prize.

19. The gaming machine of any one of claims 1 to 18, wherein the controller is further configured to store the monetary award in the memory, and generate an indication of the monetary award configured to be displayed on the display.

20. A method of determining monetary and non-monetary prizes to be awarded, the method comprising:
presenting at least one instance of at least one game of chance on a display of a gaming machine;
generating a randomised game outcome for the at least one instance of the at least one game of chance;
accessing at least one non-monetary pay table;
determining a first winning event for the at least one instance of the at least one game of chance;
accessing at least one monetary pay table
determining a second winning event for the at least one instance of the at least one game of chance;
based on the first winning event of the game of chance and the at least one non-monetary pay table, determining whether the player should be awarded a non-monetary reward; and
based on the second winning event of the game of chance and the at least one monetary pay table, determining whether the player should be awarded a monetary reward.

21. The method of claim 20, further comprising determining whether the player should be awarded a monetary reward by comparing one or more symbols generated by the game of chance with the at least one monetary pay table.

22. The method of any one of claims 20 to 21, further comprising accessing at least one non-monetary pay table to determine whether the player should be awarded a non-monetary reward.

23. The method of claim 22, further comprising determining whether the player should be awarded a non-monetary reward by comparing one or more symbols generated by the game of chance with the at least one non-monetary pay table.

24. The method of any one of claims 20 to 23, wherein the non-monetary reward contributes to progression in a chance based feature game.

25. A computer-readable medium storing machine-readable instructions, which when executed by a processor, causes the processor to perform the method of any one of claims 20 to 24.
